(19) United States
(12) Patent Application Publication
(10) Pub. No.: US 2013/0170561 A1
(43) Pub. Date: Jul. 4, 2013

(54) METHOD AND APPARATUS FOR VIDEO CODING AND DECODING

(71) Applicant: Miska Matias HANNUKSELA, Ruutana (FI)

(72) Inventor: Miska Matias HANNUKSELA, Ruutana (FI)

(73) Assignee: NOKIA CORPORATION, Espoo (FI)

(21) Appl. No.: 13/541,131

(22) Filed: Jul. 3, 2012

Related U.S. Application Data
(60) Provisional application No. 61/504,382, filed on Jul. 5, 2011.

(51) Int. Cl. H04N 7/26

(52) U.S. Cl. CPC H04N 19/00533
USPC 375/240.25

(57) ABSTRACT

A method comprises receiving a first sequence of access units and a second sequence of access units; decoding at least one access unit of the first sequence of access units; decoding a first decodable access unit of the second sequence of access units; determining whether a next decodable access unit in the second sequence of access units can be decoded before an output time of the next decodable access unit in the second sequence of access units; and skipping decoding of the next decodable access unit based on determining that the next decodable access unit cannot be decoded before the at least one of the decoding time and the output time of the next decodable access unit.

### FIELD OF INVENTION

The present invention relates generally to the field of video coding and, more specifically, to efficient stream switching in encoding and/or decoding of encoded data.

### BACKGROUND OF THE INVENTION

This section is intended to provide a background or context to the invention that is recited in the claims. The description herein may include concepts that may be pursued, but are not necessarily ones that have been previously conceived or pursued. Therefore, unless otherwise indicated herein, what is described in this section is not prior art to the description and claims in this application and is not admitted to be prior art by inclusion in this section.

In order to facilitate communication of video content over one or more networks, several coding standards have been developed. Video coding standards include ITU-T H.261, ISO/IEC MPEG-1 Video, ITU-T H.262 or ISO/IEC MPEG-2 Video, ITU-T H.263, ISO/IEC MPEG-4 Visual, ITU-T H.264 (also know as ISO/IEC MPEG-4 AVC), the scalable video coding (SVC) extension of H.264/AVC, and the multiview video coding (MVC) extension of H.264/AVC. In addition, there are currently efforts underway to develop new video coding standards. One such standard under development is the high-efficiency video coding (HEVC) standard.

The Advanced Video Coding (H.264/AVC) standard is known as ITU-T Recommendation H.264 and ISO/IEC International Standard 14496-10, also known as MPEG-4 Part 10 Advanced Video Coding (AVC). There have been several versions of the H.264/AVC standard, each integrating new features to the specification. Version 8 refers to the standard including the Scalable Video Coding (SVC) amendment. Version 10 includes the Multiview Video Coding (MVC) amendment.

Multi-level temporal scalability hierarchies enabled by H.264/AVC, SVC, MVC, and HEVC are suggested to be used due to their significant compression efficiency improvement. However, the multi-level hierarchies may also cause problems when switching between bitstreams occurs. Switching between coded streams of different bit-rates is a method that is used, for example, in unicast streaming for the Internet to match the transmitted bitrate to the expected network throughput and to avoid congestion in the network. In order to enable switching between streams, the streams share a common timeline. For example, the 3GPP and MPEG DASH specify that all Representations share the same timeline. The implication is that in the common case where all streams share the same frame rate, then the nth frame in one stream has the same presentation timestamp as the nth frame in any other stream and represents the same original picture.

### SUMMARY OF THE INVENTION

In one aspect of the invention, a method comprises receiving a first sequence of access units and a second sequence of access units; decoding at least one access unit of the first sequence of access units; decoding a first decodable access unit of the second sequence of access units; determining whether a next decodable access unit in the second sequence of access units can be decoded before at least one of a decoding time of the next decodable access unit in the second sequence of access units and an output time of the next decodable access unit in the second sequence of access units; and skipping decoding of the next decodable access unit based on determining that the next decodable access unit cannot be decoded before the at least one of the decoding time and the output time of the next decodable access unit.

In one embodiment, the method further comprises skipping decoding of any access units depending on the next decodable access unit. In one embodiment, the method further comprises decoding the next decodable access unit based on determining that the next decodable access unit can be decoded before at least one of a decoding time of the next decodable access unit in the second sequence of access units and an output time of the next decodable access unit. The determining and either the skipping decoding or the decoding the next decodable access unit may be repeated until there are no more access units. In one embodiment, the decoding of the first decodable access unit may include starting decoding at a non-continuous position relative to a previous decoding position. In one embodiment, each access unit may be one of an IDR access unit, an SVC access unit or an MVC access unit containing an anchor picture.

In another aspect of the invention, a method comprises receiving a request for switching from a first sequence of access units to a second sequence of access units from a receiver; encapsulating at least one decodable access unit of the first sequence of access units for transmission; encapsulating a first decodable access unit of the second sequence of access units for transmission; determining whether a next decodable access unit in the second sequence of access units can be encapsulated before at least one of a decoding time of the next decodable access unit in the second sequence of access units and a transmission time of the next decodable access unit in the second sequence of access units; and skipping encapsulation of the next decodable access unit based on determining that the next decodable access unit cannot be encapsulated before the at least one of the decoding time and the transmission time of the next decodable access unit; and transmitting the encapsulated decodable access units to the receiver.

In another aspect of the invention, a method comprises generating instructions for decoding a first sequence of access units and a second sequence of access units, the instructions comprising: decoding at least one access unit of the first sequence of access units; decoding a first decodable access unit of the second sequence of access units; determining whether a next decodable access unit in the second sequence of access units can be decoded before at least one of a decoding time of the next decodable access unit in the second sequence of access units and an output time of the next decodable access unit in the second sequence of access units; and skipping decoding of the next decodable access unit based on determining that the next decodable access unit cannot be decoded before the at least one of the decoding time and the output time of the next decodable access unit.

In another aspect of the invention, a method comprises generating instructions for encapsulating a first sequence of access units and a second sequence of access units, the instructions comprising: encapsulating at least one decodable access unit of the first sequence of access units; encapsulating a first decodable access unit of the second sequence of access units for transmission; determining whether a next decodable access unit in the second sequence of access units can be encapsulated before at least one of a decoding time of the next decodable access unit in the second sequence of access units and a transmission time of the next decodable access unit in the second sequence of access units; and skipping encapsulation of the next decodable access unit based on determining that the next decodable access unit cannot be encapsulated before the at least one of the decoding time and the transmission time of the next decodable access unit

In another aspect of the invention, an apparatus comprises a decoder configured to decode at least one access unit of a first sequence of access units; decode a first decodable access unit of a second sequence of access units; determine whether a next decodable access unit in the second sequence of access units can be decoded before at least one of a decoding time of the next decodable access unit in the second sequence of access units and an output time of the next decodable access unit in the second sequence of access units; and skip decoding of the next decodable access unit based on determining that the next decodable access unit cannot be decoded before the at least one of the decoding time and the output time of the next decodable access unit.

In another aspect of the invention, an apparatus comprises an encoder configured to encapsulate at least one decodable access unit of a first sequence of access units for transmission; encapsulate a first decodable access unit of a second sequence of access units for transmission; determine whether a next decodable access unit in the second sequence of access units can be encapsulated before at least one of a decoding time of the next decodable access unit in the second sequence of access units and a transmission time of the next decodable access unit in the second sequence of access units; and skip encapsulation of the next decodable access unit based on determining that the next decodable access unit cannot be encapsulated before the at least one of the decoding time and the transmission time of the next decodable access unit.

In another aspect of the invention, an apparatus comprises a file generator configured to generate instructions to: decode at least one access unit of a first sequence of access units; decode a first decodable access unit of a second sequence of access units; determine whether a next decodable access unit in the second sequence of access units can be decoded before at least one of a decoding time of the next decodable access unit in the second sequence of access units and an output time of the next decodable access unit in the second sequence of access units; and skip decoding of the next decodable access unit based on determining that the next decodable access unit cannot be decoded before the at least one of the decoding time and the output time of the next decodable access unit

In another aspect of the invention, an apparatus comprises a file generator configured to generate instructions to: encapsulate at least one decodable access unit of a first sequence of access units for transmission; encapsulate a first decodable access unit of a second sequence of access units for transmission; determine whether a next decodable access unit in the second sequence of access units can be encapsulated before at least one of a decoding time of the next decodable access unit in the second sequence of access units and a transmission time of the next decodable access unit in the second sequence of access units; and skip encapsulation of the next decodable access unit based on determining that the next decodable access unit cannot be encapsulated before the at least one of the decoding time and the transmission time of the next decodable access unit

In another aspect of the invention, an apparatus comprises at least one processor and at least one memory. The memory unit includes computer program code. The at least one memory and the computer program code are configured to, with the at least one processor, cause the apparatus at least to decode at least one access unit of a first sequence of access units; decode a first decodable access unit of a second sequence of access units; determine whether a next decodable access unit in the second sequence of access units can be decoded before at least one of a decoding time of the next decodable access unit in the second sequence of access units and an output time of the next decodable access unit in the second sequence of access units; and skip decoding of the next decodable access unit based on determining that the next decodable access unit cannot be decoded before the at least one of the decoding time and the output time of the next decodable access unit.

In another aspect of the invention, an apparatus comprises at least one processor and at least one memory. The memory unit includes computer program code. The at least one memory and the computer program code are configured to, with the at least one processor, cause the apparatus at least to encapsulate at least one access unit of a first sequence of access units for transmission; encapsulate a first decodable access unit of a second sequence of access units for transmission; determine whether a next decodable access unit in the second sequence of access units can be encapsulated before at least one of a decoding time of the next decodable access unit in the second sequence of access units and a transmission time of the next decodable access unit in the second sequence of access units; and skip encapsulation of the next decodable access unit based on determining that the next decodable access unit cannot be encapsulated before the at least one of the decoding time and the transmission time of the next decodable access unit.

In another aspect of the invention, a computer program product is embodied on a computer-readable medium and comprises computer code for decoding at least one access unit of a first sequence of access units; computer code for decoding a first decodable access unit of a second sequence of access units; computer code for determining whether a next decodable access unit in the second sequence of access units can be decoded before at least one of a decoding time of the next decodable access unit in the second sequence of access units and an output time of the next decodable access unit in the second sequence of access units; and computer code for skipping decoding of the next decodable access unit based on determining that the next decodable access unit cannot be decoded before the at least one of the decoding time and the output time of the next decodable access unit.

In another aspect of the invention, a computer program product is embodied on a computer-readable medium and comprises computer code for encapsulating at least one access unit of a first sequence of access units for transmission; computer code for encapsulating a first decodable access unit of a second sequence of access units for transmission; computer code for determining whether a next decodable access unit in the second sequence of access units can be encapsulated before at least one of a decoding time of the next decodable access unit in the second sequence of access units and a transmission time of the next decodable access unit in the second sequence of access units; and computer code for skipping encapsulation of the next decodable access unit based on determining that the next decodable access unit cannot be encapsulated before the at least one of the decoding time and the transmission time of the next decodable access unit.

These and other advantages and features of various embodiments of the present invention, together with the organization and manner of operation thereof, will become apparent from the following detailed description when taken in conjunction with the accompanying drawings.

### BRIEF DESCRIPTION OF THE DRAWINGS

Embodiments of the invention are described by referring to the attached drawings, in which:

FIG. 1 illustrates an example hierarchical coding structure with temporal scalability;

FIG. 2a illustrates an example box in accordance with the ISO base media file format;

FIG. 2b shows an example of a simplified file structure according to the ISO base media file format;

FIG. 3 is an example box illustrating sample grouping;

FIG. 4 illustrates an example box containing a movie fragment including a SampletoToGroup box;

FIG. 5 depicts an example of the structure of an AVC sample;

FIG. 6 depicts an example of a media presentation description XML schema;

FIGS. 7a-7c illustrate an example hierarchically scalable bitstream with five temporal levels;

FIG. 8 is a flowchart illustrating an example implementation in accordance with an embodiment of the present invention;

FIGS. 9a-9c illustrate example sequences in capture order, decoding order and output order;

FIGS. 10a-10b illustrate example sequences of FIG. 9a in decoding order and in output order, respectively, in connection with switching from one stream to the other stream of FIG. 9a in accordance with embodiments of the present invention;

FIGS. 10c-10d illustrate example sequences of FIG. 9a in decoding order and in output order, respectively, in connection with switching from one stream to the other stream of FIG. 9a using a delayed switching;

FIGS. 11a-11b illustrate an example of an alternative sequence starting from a switching point implemented to the sequence of FIG. 7a;

FIGS. 11c-11d illustrate another example of an alternative sequence starting from a switching point implemented to the sequence of FIG. 7a;

FIG. 12 is an overview diagram of a system within which various embodiments of the present invention may be implemented;

FIG. 13 illustrates a perspective view of an exemplary electronic device which may be utilized in accordance with the various embodiments of the present invention;

FIG. 14 is a schematic representation of the circuitry which may be included in the electronic device of FIG. 13; and

FIG. 15 is a graphical representation of a generic multimedia communication system within which various embodiments may be implemented;

FIG. 16 depicts an example illustration of some functional blocks, formats, and interfaces included in an HTTP streaming system;

FIG. 17 depicts an example of a file structure for server file format where one file contains metadata fragments constituting the entire duration of a presentation;

FIG. 18 illustrates an example of a regular web server operating as a HTTP streaming server; and

FIG. 19 illustrates an example of a regular web server connected with a dynamic streaming server.

### DETAILED DESCRIPTION OF THE VARIOUS EMBODIMENTS

In the following description, for purposes of explanation and not limitation, details and descriptions are set forth in order to provide a thorough understanding of the present invention. However, it will be apparent to those skilled in the art that the present invention may be practiced in other embodiments that depart from these details and descriptions.

As noted above, the Advanced Video Coding (H.264/AVC) standard is known as ITU-T Recommendation H.264 and ISO/IEC International Standard 14496-10, also known as MPEG-4 Part 10 Advanced Video Coding (AVC). There have been several versions of the H.264/AVC standard, each integrating new features to the specification. Version 8 refers to the standard including the Scalable Video Coding (SVC) amendment. Version 10 includes the Multiview Video Coding (MVC) amendment.

Similarly to earlier video coding standards, the bitstream syntax and semantics as well as the decoding process for error-free bitstreams are specified in H.264/AVC. The encoding process is not specified. Bitstream and decoder conformance can be verified with the Hypothetical Reference Decoder (HRD), which is specified in Annex C of H.264/AVC. The standard contains coding tools that help in coping with transmission errors and losses, but the use of the tools in encoding is optional and no decoding process has been specified for erroneous bitstreams.

The elementary unit for the input to an H.264/AVC encoder and the output of an H.264/AVC decoder is a picture. A picture may either be a frame or a field. A frame comprises a matrix of luma samples and corresponding chroma samples. A field is a set of alternate sample rows of a frame and may be used as encoder input, when the source signal is interlaced. A macroblock is a 16×16 block of luma samples and the corresponding blocks of chroma samples. A picture is partitioned to one or more slice groups, and a slice group contains one or more slices. A slice includes an integer number of macroblocks ordered consecutively in the raster scan within a particular slice group.

The elementary unit for the output of an H.264/AVC encoder and the input of an H.264/AVC decoder is a Network Abstraction Layer (NAL) unit. Decoding of partial or corrupted NAL units is typically remarkably difficult. For transport over packet-oriented networks or storage into structured files, NAL units are typically encapsulated into packets or similar structures. A bytestream format has been specified in H.264/AVC for transmission or storage environments that do not provide framing structures. The bytestream format separates NAL units from each other by attaching a start code in front of each NAL unit. To avoid false detection of NAL unit boundaries, encoders run a byte-oriented start code emulation prevention algorithm, which adds an emulation prevention byte to the NAL unit payload if a start code would have occurred otherwise. In order to enable straightforward gateway operation between packet- and stream-oriented systems, start code emulation prevention is performed always regardless of whether the bytestream format is in use or not.

The bitstream syntax of H.264/AVC indicates whether or not a particular picture is a reference picture for inter prediction of any other picture. Consequently, a picture not used for prediction, a non-reference picture, can be safely disposed. Pictures of any coding type (I, P, B) can be reference pictures or non-reference pictures in H.264/AVC. The NAL unit header indicates the type of the NAL unit and whether a coded slice contained in the NAL unit is a part of a reference picture or a non-reference picture.

H.264/AVC specifies the process for decoded reference picture marking in order to control the memory consumption in the decoder. The maximum number of reference pictures used for inter prediction, referred to as M, is determined in the sequence parameter set. When a reference picture is decoded, it is marked as “used for reference”. If the decoding of the reference picture caused more than M pictures marked as “used for reference”, at least one picture is marked as “unused for reference”. There are two types of operation for decoded reference picture marking: adaptive memory control and sliding window. The operation mode for decoded reference picture marking is selected on picture basis. The adaptive memory control enables explicit signaling which pictures are marked as “unused for reference” and may also assign long-term indices to short-term reference pictures. The adaptive memory control requires the presence of memory management control operation (MMCO) parameters in the bitstream. If the sliding window operation mode is in use and there are M pictures marked as “used for reference”, the short-term reference picture that was the first decoded picture among those short-term reference pictures that are marked as “used for reference” is marked as “unused for reference”. In other words, the sliding window operation mode results into first-in-first-out buffering operation among short-term reference pictures.

One of the memory management control operations in H.264/AVC causes all reference pictures except for the current picture to be marked as “unused for reference”. An instantaneous decoding refresh (IDR) picture contains only intra-coded slices and causes a similar “reset” of reference pictures.

The reference picture for inter prediction is indicated with an index to a reference picture list. The index is coded with variable length coding, i.e., the smaller the index is, the shorter the corresponding syntax element becomes. Two reference picture lists are generated for each bi-predictive slice of H.264/AVC, and one reference picture list is formed for each inter-coded slice of H.264/AVC. A reference picture list is constructed in two steps: first, an initial reference picture list is generated, and then the initial reference picture list may be reordered by reference picture list reordering (RPLR) commands contained in slice headers. The RPLR commands indicate the pictures that are ordered to the beginning of the respective reference picture list.

The frame_num syntax element is used for various decoding processes related to multiple reference pictures. In H.264/AVC, the value of frame_num for IDR pictures is 0. The value of frame_num for non-IDR pictures is equal to the frame_num of the previous reference picture in decoding order incremented by 1 (in modulo arithmetic, i.e., the value of frame_num wrap over to 0 after a maximum value of frame_num).

A value of picture order count (POC) is derived for each picture and is non-decreasing with increasing picture position in output order relative to the previous IDR picture or a picture containing a memory management control operation marking all pictures as “unused for reference”. POC therefore indicates the output order of pictures. It is also used in the decoding process for implicit scaling of motion vectors in the temporal direct mode of bi-predictive slices, for implicitly derived weights in weighted prediction, and for reference picture list initialization of B slices. Furthermore, POC is used in the verification of output order conformance.

The hypothetical reference decoder (HRD), specified in Annex C of H.264/AVC, is used to check bitstream and decoder conformance. The HRD contains a coded picture buffer (CPB), an instantaneous decoding process, a decoded picture buffer (DPB), and an output picture cropping block. The CPB and the instantaneous decoding process are specified similarly to any other video coding standard, and the output picture cropping block simply crops those samples from the decoded picture that are outside the signaled output picture extents.

The operation of the coded picture buffering in the HRD can be simplified as follows. It is assumed that bits arrive into the CPB at a constant arrival bitrate. Hence, coded pictures or access units are associated with initial arrival time, which indicates when the first bit of the coded picture or access unit enters the CPB. Furthermore, the coded pictures or access units are assumed to be removed instantaneously when the last bit of the coded picture or access unit is inserted into CPB and the respective decoded picture is inserted then to the DPB, thus simulating instantaneous decoding. This time is referred to as the removal time of the coded picture or access unit. The removal time of the first coded picture of the coded video sequence is typically controlled, for example by the Buffering Period Supplemental Enhancement Information (SEI) message. This so-called initial coded picture removal delay ensures that any variations of the coded bitrate, with respect to the constant bitrate used to fill in the CPB, do not cause starvation or overflow of the CPB. It is to be understood that the operation of the HRD is somewhat more sophisticated than what described here, having for example the low-delay operation mode and the capability to operate at many different constant bitrates.

The DPB is used to control the required memory resources for decoding of conformant bitstreams. There are two reasons to buffer decoded pictures, for references in inter prediction and for reordering decoded pictures into output order. As H.264/AVC provides a great deal of flexibility for both reference picture marking and output reordering, separate buffers for reference picture buffering and output picture buffering could have been a waste of memory resources. Hence, the DPB includes a unified decoded picture buffering process for reference pictures and output reordering. A decoded picture is removed from the DPB when it is no longer used as reference and needed for output. The maximum size of the DPB that bitstreams are allowed to use is specified in the Level definitions (Annex A) of H.264/AVC.

There are two types of conformance for decoders: output timing conformance and output order conformance. For output timing conformance, a decoder outputs pictures at identical times compared to the HRD. For output order conformance, only the correct order of output picture is taken into account. The output order DPB is assumed to contain a maximum allowed number of frame buffers. A frame is removed from the DPB when it is no longer used as a reference and needed for output. When the DPB becomes full, the earliest frame in output order is output until at least one frame buffer becomes unoccupied.

Picture timing and the operation of the HRD may be controlled by two Supplemental Enhancement Information (SEI) messages: Buffering Period and Picture Timing SEI messages. The Buffering Period SEI message specifies the initial CPB removal delay. The Picture Timing SEI message specifies other delays (cpb_removal_delay and dpb_removal_delay) related to the operation of the HRD as well as the output times of the decoded pictures. The information of Buffering Period and Picture Timing SEI messages may also be conveyed through other means and need not be included into H.264/AVC bitstreams.

NAL units can be categorized into Video Coding Layer (VCL) NAL units and non-VCL NAL units. VCL NAL units are either coded slice NAL units, coded slice data partition NAL units, or VCL prefix NAL units. Coded slice NAL units contain syntax elements representing one or more coded macroblocks, each of which corresponds to a block of samples in the uncompressed picture. There are four types of coded slice NAL units: coded slice in an Instantaneous Decoding Refresh (IDR) picture, coded slice in a non-IDR picture, coded slice of an auxiliary coded picture (such as an alpha plane) and coded slice extension (for coded slices in scalable or multiview extensions). A set of three coded slice data partition NAL units contains the same syntax elements as a coded slice. Coded slice data partition A comprises macroblock headers and motion vectors of a slice, while coded slice data partition B and C include the coded residual data for intra macroblocks and inter macroblocks, respectively. A VCL prefix NAL unit precedes a coded slice of the base layer in SVC bitstreams and contains indications of the scalability hierarchy of the associated coded slice.

A non-VCL NAL unit may be of one of the following types: a sequence parameter set, a picture parameter set, a supplemental enhancement information (SEI) NAL unit, an access unit delimiter, an end of sequence NAL unit, an end of stream NAL unit, or a filler data NAL unit. Parameter sets are essential for the reconstruction of decoded pictures, whereas the other non-VCL NAL units are not necessary for the reconstruction of decoded sample values and serve other purposes.

In order to transmit infrequently changing coding parameters robustly, the parameter set mechanism was adopted to H.264/AVC. Parameters that remain unchanged through a coded video sequence are included in a sequence parameter set. In addition to the parameters that are essential to the decoding process, the sequence parameter set may optionally contain video usability information (VUI), which includes parameters that are important for buffering, picture output timing, rendering, and resource reservation. A picture parameter set contains such parameters that are likely to be unchanged in several coded pictures. No picture header is present in H.264/AVC bitstreams but the frequently changing picture-level data is repeated in each slice header and picture parameter sets carry the remaining picture-level parameters. H.264/AVC syntax allows many instances of sequence and picture parameter sets, and each instance is identified with a unique identifier. Each slice header includes the identifier of the picture parameter set that is active for the decoding of the picture that contains the slice, and each picture parameter set contains the identifier of the active sequence parameter set. Consequently, the transmission of picture and sequence parameter sets does not have to be accurately synchronized with the transmission of slices. Instead, it is sufficient that the active sequence and picture parameter sets are received at any moment before they are referenced, which allows transmission of parameter sets using a more reliable transmission mechanism compared to the protocols used for the slice data. For example, parameter sets can be included as a parameter in the session description for H.264/AVC RTP sessions. It is recommended to use an out-of-band reliable transmission mechanism whenever it is possible in the application in use. If parameter sets are transmitted in-band, they can be repeated to improve error robustness.

A SEI NAL unit contains one or more SEI messages, which are not required for the decoding of output pictures but assist in related processes, such as picture output timing, rendering, error detection, error concealment, and resource reservation. Several SEI messages are specified in H.264/AVC, and the user data SEI messages enable organizations and companies to specify SEI messages for their own use. H.264/AVC contains the syntax and semantics for the specified SEI messages but no process for handling the messages in the recipient is defined. Consequently, encoders follow the H.264/AVC standard when they create SEI messages, and decoders conforming to the H.264/AVC standard are not required to process SEI messages for output order conformance. One of the reasons to include the syntax and semantics of SEI messages in H.264/AVC is to allow different system specifications to interpret the supplemental information identically and hence interoperate. It is intended that system specifications can require the use of particular SEI messages both in the encoding end and in the decoding end, and additionally the process for handling particular SEI messages in the recipient can be specified.

A coded picture includes the VCL NAL units that are required for the decoding of the picture. A coded picture can be a primary coded picture or a redundant coded picture. A primary coded picture is used in the decoding process of valid bitstreams, whereas a redundant coded picture is a redundant representation that should only be decoded when the primary coded picture cannot be successfully decoded.

An access unit includes a primary coded picture and those NAL units that are associated with it. The appearance order of NAL units within an access unit is constrained as follows. An optional access unit delimiter NAL unit may indicate the start of an access unit. It is followed by zero or more SEI NAL units. The coded slices or slice data partitions of the primary coded picture appear next, followed by coded slices for zero or more redundant coded pictures.

A coded video sequence is defined to be a sequence of consecutive access units in decoding order from an IDR access unit, inclusive, to the next IDR access unit, exclusive, or to the end of the bitstream, whichever appears earlier.

H.264/AVC enables hierarchical temporal scalability. Its extensions SVC and MVC provide some additional indications, particularly the temporal_id syntax element in the NAL unit header, which makes the use of temporal scalability more straightforward. Temporal scalability provides refinement of the video quality in the temporal domain, by giving flexibility of adjusting the frame rate. A review of different types of scalability offered by SVC is provided in the subsequent paragraphs and a more detailed review of temporal scalability is provided further below.

In scalable video coding, a video signal can be encoded into a base layer and one or more enhancement layers constructed. An enhancement layer enhances the temporal resolution (i.e., the frame rate), the spatial resolution, or simply the quality of the video content represented by another layer or part thereof. Each layer together with all its dependent layers is one representation of the video signal at a certain spatial resolution, temporal resolution and quality level. In this document, we refer to a scalable layer together with all of its dependent layers as a “scalable layer representation”. The portion of a scalable bitstream corresponding to a scalable layer representation can be extracted and decoded to produce a representation of the original signal at certain fidelity.

In some cases, data in an enhancement layer can be truncated after a certain location, or even at arbitrary positions, where each truncation position may include additional data representing increasingly enhanced visual quality. Such scalability is referred to as fine-grained (granularity) scalability (FGS). It should be mentioned that support of FGS was not included in the SVC standard, but the support is available in earlier SVC drafts, e.g., in JVT-U201, “Joint Draft 8 of SVC Amendment”, 21^{st} JVT meeting, Hangzhou, China, October 2006, available from http://ftp3.itu.ch/av-arch/jvt-site/2006_{—}10_Hangzhou/JVT-U201.zip. In contrast to FGS, the scalability provided by those enhancement layers that cannot be truncated is referred to as coarse-grained (granularity) scalability (CGS). It collectively includes the traditional quality (SNR) scalability and spatial scalability. The SVC draft standard also supports the so-called medium-grained scalability (MGS), where quality enhancement pictures are coded similarly to SNR scalable layer pictures but indicated by high-level syntax elements similarly to FGS layer pictures, by having the quality_id syntax element greater than 0.

SVC uses an inter-layer prediction mechanism, wherein certain information can be predicted from layers other than the currently reconstructed layer or the next lower layer. Information that could be inter-layer predicted includes intra texture, motion and residual data. Inter-layer motion prediction includes the prediction of block coding mode, header information, etc., wherein motion from the lower layer may be used for prediction of the higher layer. In case of intra coding, a prediction from surrounding macroblocks or from co-located macroblocks of lower layers is possible. These prediction techniques do not employ information from earlier coded access units and hence, are referred to as intra prediction techniques. Furthermore, residual data from lower layers can also be employed for prediction of the current layer.

The scalability structure in the SVC draft is characterized by three syntax elements: “temporal_id,” “dependency_id” and “quality_id.” The syntax element “temporal_id” is used to indicate the temporal scalability hierarchy or, indirectly, the frame rate. A scalable layer representation comprising pictures of a smaller maximum “temporal_id” value has a smaller frame rate than a scalable layer representation comprising pictures of a greater maximum “temporal_id.” A given temporal layer typically depends on the lower temporal layers (i.e., the temporal layers with smaller “temporal_id” values) but does not depend on any higher temporal layer. The syntax element “dependency_id” is used to indicate the CGS inter-layer coding dependency hierarchy (which, as mentioned earlier, includes both SNR and spatial scalability). At any temporal level location, a picture of a smaller “dependency_id” value may be used for inter-layer prediction for coding of a picture with a greater “dependency_id” value. The syntax element “quality_id” is used to indicate the quality level hierarchy of a FGS or MGS layer. At any temporal location, and with an identical “dependency_id” value, a picture with “quality_id” equal to QL uses the picture with “quality_id” equal to QL−1 for inter-layer prediction. A coded slice with “quality_id” larger than 0 may be coded as either a truncatable FGS slice or a non-truncatable MGS slice.

For simplicity, all the data units (e.g., Network Abstraction Layer units or NAL units in the SVC context) in one access unit having identical value of “dependency_id” are referred to as a dependency unit or a dependency representation. Within one dependency unit, all the data units having identical value of “quality_id” are referred to as a quality unit or layer representation.

A base representation, also known as a decoded base picture or a reference base picture, is a decoded picture resulting from decoding the Video Coding Layer (VCL) NAL units of a dependency unit having “quality_id” equal to 0 and for which the “store_ref_base_pic_flag” is set equal to 1. An enhancement representation, also referred to as a decoded picture, results from the regular decoding process in which all the layer representations that are present for the highest dependency representation are decoded.

Each H.264/AVC VCL NAL unit (with NAL unit type in the scope of 1 to 5) is preceded by a prefix NAL unit in an SVC bitstream. A compliant H.264/AVC decoder implementation ignores prefix NAL units. The prefix NAL unit includes the “temporal_id” value and hence an SVC decoder, that decodes the base layer, can learn from the prefix NAL units the temporal scalability hierarchy. Moreover, the prefix NAL unit includes reference picture marking commands for base representations.

SVC uses the same mechanism as H.264/AVC to provide temporal scalability. Temporal scalability provides refinement of the video quality in the temporal domain, by giving flexibility of adjusting the frame rate. A review of temporal scalability is provided in the subsequent paragraphs.

The earliest scalability introduced to video coding standards was temporal scalability with B pictures in MPEG-1 Visual. In this B picture concept, a B picture is bi-predicted from two pictures, one preceding the B picture and the other succeeding the B picture, both in display order. In bi-prediction, two prediction blocks from two reference pictures are averaged sample-wise to get the final prediction block. Conventionally, a B picture is a non-reference picture (i.e., it is not used for inter-picture prediction reference by other pictures). Consequently, the B pictures could be discarded to achieve a temporal scalability point with a lower frame rate. The same mechanism was retained in MPEG-2 Video, H.263 and MPEG-4 Visual.

In H.264/AVC, the concept of B pictures or B slices has been changed. The definition of B slice is as follows: A slice that may be decoded using intra prediction from decoded samples within the same slice or inter prediction from previously-decoded reference pictures, using at most two motion vectors and reference indices to predict the sample values of each block. Both the bi-directional prediction property and the non-reference picture property of the conventional B picture concept are no longer valid. A block in a B slice may be predicted from two reference pictures in the same direction in display order, and a picture including B slices may be referred by other pictures for inter-picture prediction.

In H.264/AVC, SVC, and MVC, temporal scalability can be achieved by using non-reference pictures and/or hierarchical inter-picture prediction structure. Using only non-reference pictures is able to achieve similar temporal scalability as using conventional B pictures in MPEG-1/2/4, by discarding non-reference pictures. Hierarchical coding structure can achieve more flexible temporal scalability.

Switching to another coded stream is typically possible at a random access point. However, the initial buffering requirements for the switch-to stream may be longer than buffering delays of the switch-from stream at the point of the switch and hence there may be a glitch in the playback. Video playback cannot continue seamlessly but the last picture(s) of the switch-from stream are displayed for a longer period than the regular picture interval. While it might be hard to perceive small variations of video frame rate, lip synchronization to the audio stream may be maintained and hence there may be a small interruption or glitch in audio playback. Such an audio interruption can be easily observed and may be found annoying. Another possibility would be to render audio and video out of synchronization but such asynchrony may also be perceived and may be found annoying.

The initial buffering requirements for the switch-to stream may be longer than buffering delays of the switch-from stream at the point of the switch due to at least two reasons:

First, when the output timelines of switch-from and switch-to streams are the same, the decoding process of the switch-to stream may be required to be started earlier than the decoding process of the switch-from stream ends. In other words, the time when the decoding of the last coded picture of the switch-from stream ends may be later than the time of the first coded picture of the switch-to stream starts. In terms of the Hypothetical Reference Decoder (HRD) of H.264/AVC, the removal time of the last access unit in the switch-from stream may be later than the initial arrival time of the first access unit in the switch-to stream. Yet another way to state this challenge is that the decoding duration, on the decoding timeline, of the last picture of the switch-from stream may overlap with that of the first sample of the switch-to stream.

Second, the temporal prediction/scalability hierarchy of the streams may differ and hence the initial decoded picture buffering delay may differ in the switch-from and switch-to streams.

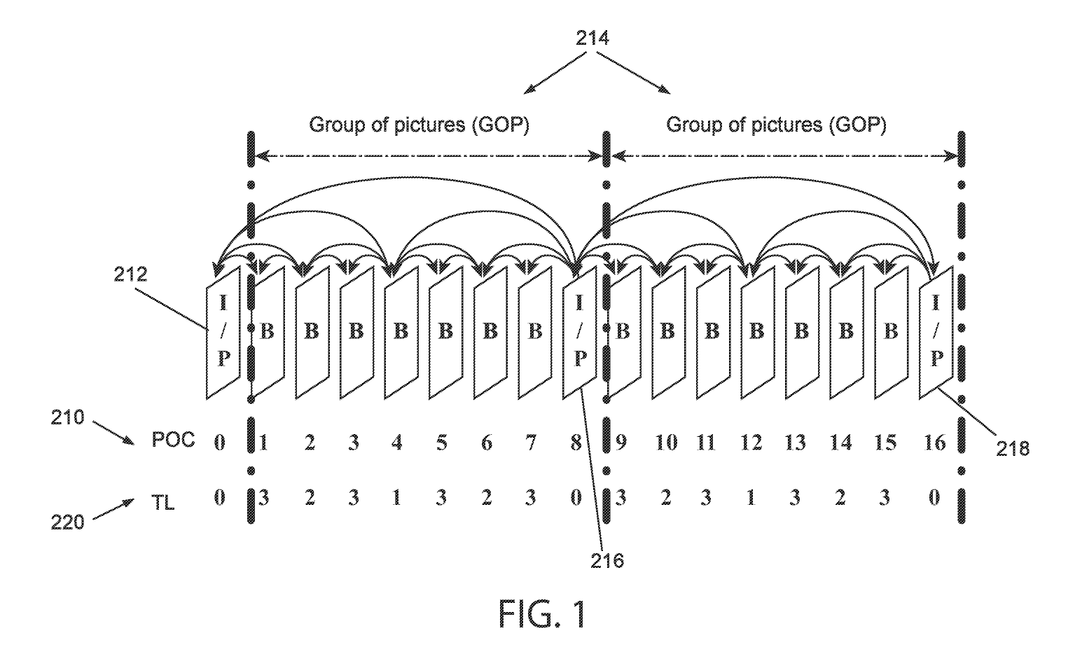

Referring now to FIG. 1, an exemplary hierarchical coding structure is illustrated with four levels of temporal scalability. The display order is indicated by the values denoted as picture order count (POC) 210. The I or P pictures at temporal level (TL) 0, such as I/P picture 212, also referred to as key pictures, are coded as the first picture of a group of pictures (GOPs) 214 in decoding order. When a key picture (e.g., key picture 216, 218) is inter-coded, the previous key pictures 212, 216 are used as reference for inter-picture prediction. These pictures correspond to the lowest temporal level 220 (denoted as TL in the figure) in the temporal scalable structure and are associated with the lowest frame rate. Pictures of a higher temporal level may only use pictures of the same or lower temporal level for inter-picture prediction. With such a hierarchical coding structure, different temporal scalability corresponding to different frame rates can be achieved by discarding pictures of a certain temporal level value and beyond. In FIG. 1, the pictures 0, 8 and 16 are of the lowest temporal level, while the pictures 1, 3, 5, 7, 9, 11, 13 and 15 are of the highest temporal level. Other pictures are assigned with other temporal level hierarchically. These pictures of different temporal levels compose the bitstream of different frame rate. When decoding all the temporal levels, a frame rate of 30 Hz is obtained (assuming that the original sequence that was encoded had 30 Hz frame rate). Other frame rates can be obtained by discarding pictures of some temporal levels. The pictures of the lowest temporal level are associated with the frame rate of 3.75 Hz. A temporal scalable layer with a lower temporal level or a lower frame rate is also called as a lower temporal layer.

The above-described hierarchical B picture coding structure is the most typical coding structure for temporal scalability. However, it is noted that much more flexible coding structures are possible. For example, the GOP size may not be constant over time. In another example, the temporal enhancement layer pictures do not have to be coded as B slices; they may also be coded as P slices.

In H.264/AVC, the temporal level may be signaled by the sub-sequence layer number in the sub-sequence information Supplemental Enhancement Information (SEI) messages. In SVC and MVC, the temporal level may be signaled in the Network Abstraction Layer (NAL) unit header by the syntax element “temporal_id.” The bitrate and frame rate information for each temporal level may be signaled in the scalability information SEI message.

Random access refers to the ability of the decoder to start decoding a stream at a point other than the beginning of the stream and recover an exact or approximate representation of the decoded pictures. A random access point and a recovery point characterize a random access operation. The random access point is any coded picture where decoding can be initiated. All decoded pictures at or subsequent to a recovery point in output order are correct or approximately correct in content. If the random access point is the same as the recovery point, the random access operation is instantaneous; otherwise, it is gradual.

Random access points enable seek, fast forward, and fast backward operations in locally stored video streams. In video on-demand streaming, servers can respond to seek requests by transmitting data starting from the random access point that is closest to the requested destination of the seek operation. Switching between coded streams of different bit-rates is a method that is used commonly in unicast streaming to match the transmitted bitrate to the expected network throughput and to avoid congestion in the network. Switching to another stream is possible at a random access point. Furthermore, random access points enable tuning in to a broadcast or multicast. In addition, a random access point can be coded as a response to a scene cut in the source sequence or as a response to an intra picture update request.

Conventionally each intra picture has been a random access point in a coded sequence. The introduction of multiple reference pictures for inter prediction caused that an intra picture may not be sufficient for random access. For example, a decoded picture before an intra picture in decoding order may be used as a reference picture for inter prediction after the intra picture in decoding order. Therefore, an IDR picture as specified in the H.264/AVC standard or an intra picture having similar properties to an IDR picture has to be used as a random access point. A closed group of pictures (GOP) is such a group of pictures in which all pictures can be correctly decoded. In H.264/AVC, a closed GOP may start from an IDR access unit (or from an intra coded picture with a memory management control operation marking all prior reference pictures as unused).

An open group of pictures (GOP) is such a group of pictures in which pictures preceding the initial intra picture in output order may not be correctly decodable but pictures following the initial intra picture are correctly decodable. An H.264/AVC decoder can recognize an intra picture starting an open GOP from the recovery point SEI message in the H.264/AVC bitstream. The pictures preceding the initial intra picture starting an open GOP are referred to as leading pictures. There are two types of leading pictures: decodable and non-decodable. Decodable leading pictures are such that can be correctly decoded when the decoding is started from the initial intra picture starting the open GOP. In other words, decodable leading pictures use only the initial intra picture or subsequent pictures in decoding order as reference in inter prediction. Non-decodable leading pictures are such that cannot be correctly decoded when the decoding is started from the initial intra picture starting the open GOP. In other words, non-decodable leading pictures use pictures prior, in decoding order, to the initial intra picture starting the open GOP as references in inter prediction. Amendment 1 of the ISO Base Media File Format (Edition 3) includes support for indicating decodable and non-decodable leading pictures through the leading syntax element in the Sample Dependency Type box and the leading syntax element included in sample flags that can be used in track fragments.

It is noted that the term GOP is used differently in the context of random access than in the context of SVC. In SVC, a GOP refers to the group of pictures from a picture having temporal_id equal to 0, inclusive, to the next picture having temporal_id equal to 0, exclusive, as illustrated in FIG. 1. In the random access context, a GOP is a group of pictures that can be decoded regardless of the fact whether any earlier pictures in decoding order have been decoded.

Gradual decoding refresh (GDR) refers to the ability to start the decoding at a non-IDR picture and recover decoded pictures that are correct in content after decoding a certain amount of pictures. That is, GDR can be used to achieve random access from non-intra pictures. Some reference pictures for inter prediction may not be available between the random access point and the recovery point, and therefore some parts of decoded pictures in the gradual decoding refresh period cannot be reconstructed correctly. However, these parts are not used for prediction at or after the recovery point, which results into error-free decoded pictures starting from the recovery point.

It is obvious that gradual decoding refresh is more cumbersome both for encoders and decoders compared to instantaneous decoding refresh. However, gradual decoding refresh may be desirable in error-prone environments thanks to two facts: First, a coded intra picture is generally considerably larger than a coded non-intra picture. This makes intra pictures more susceptible to errors than non-intra pictures, and the errors are likely to propagate in time until the corrupted macroblock locations are intra-coded. Second, intra-coded macroblocks are used in error-prone environments to stop error propagation. Thus, it makes sense to combine the intra macroblock coding for random access and for error propagation prevention, for example, in video conferencing and broadcast video applications that operate on error-prone transmission channels. This conclusion is utilized in gradual decoding refresh.

Gradual decoding refresh can be realized with the isolated region coding method. An isolated region in a picture can contain any macroblock locations, and a picture can contain zero or more isolated regions that do not overlap. A leftover region is the area of the picture that is not covered by any isolated region of a picture. When coding an isolated region, in-picture prediction is disabled across its boundaries. A leftover region may be predicted from isolated regions of the same picture.

A coded isolated region can be decoded without the presence of any other isolated or leftover region of the same coded picture. It may be necessary to decode all isolated regions of a picture before the leftover region. An isolated region or a leftover region contains at least one slice.

Pictures, whose isolated regions are predicted from each other, are grouped into an isolated-region picture group. An isolated region can be inter-predicted from the corresponding isolated region in other pictures within the same isolated-region picture group, whereas inter prediction from other isolated regions or outside the isolated-region picture group is disallowed. A leftover region may be inter-predicted from any isolated region. The shape, location, and size of coupled isolated regions may evolve from picture to picture in an isolated-region picture group.

An evolving isolated region can be used to provide gradual decoding refresh. A new evolving isolated region is established in the picture at the random access point, and the macroblocks in the isolated region are intra-coded. The shape, size, and location of the isolated region evolve from picture to picture. The isolated region can be inter-predicted from the corresponding isolated region in earlier pictures in the gradual decoding refresh period. When the isolated region covers the whole picture area, a picture completely correct in content is obtained when decoding started from the random access point. This process can also be generalized to include more than one evolving isolated region that eventually cover the entire picture area.

There may be tailored in-band signaling, such as the recovery point SEI message, to indicate the gradual random access point and the recovery point for the decoder. Furthermore, the recovery point SEI message includes an indication whether an evolving isolated region is used between the random access point and the recovery point to provide gradual decoding refresh.

While many of the embodiments of the present invention are described with reference to H.264/AVC, SVC, and/or MVC, it is to be understood that many of the embodiments could be applied to other video coding schemes, such as HEVC and MPEG-2 Visual, as well as to other coding schemes which inherit similar buffering to coded picture buffering and/or decoded picture buffering.

RTP is used for transmitting continuous media data, such as coded audio and video streams in Internet Protocol (IP) based networks. The Real-time Transport Control Protocol (RTCP) is a companion of RTP, i.e., RTCP should be used to complement RTP, when the network and application infrastructure allow its use. RTP and RTCP are usually conveyed over the User Datagram Protocol (UDP), which, in turn, is conveyed over the Internet Protocol (IP). RTCP is used to monitor the quality of service provided by the network and to convey information about the participants in an ongoing session. RTP and RTCP are designed for sessions that range from one-to-one communication to large multicast groups of thousands of end-points. In order to control the total bitrate caused by RTCP packets in a multiparty session, the transmission interval of RTCP packets transmitted by a single end-point is proportional to the number of participants in the session. Each media coding format has a specific RTP payload format, which specifies how media data is structured in the payload of an RTP packet.

Available media file format standards include ISO base media file format (ISO/IEC 14496-12), MPEG-4 file format (ISO/IEC 14496-14, also known as the MP4 format), AVC file format (ISO/IEC 14496-15), 3GPP file format (3GPP TS 26.244, also known as the 3GP format), and DVB file format. The SVC and MVC file formats are specified as amendments to the AVC file format. The ISO file format is the base for derivation of all the above mentioned file formats (excluding the ISO file format itself). These file formats (including the ISO file format itself) are called the ISO family of file formats.

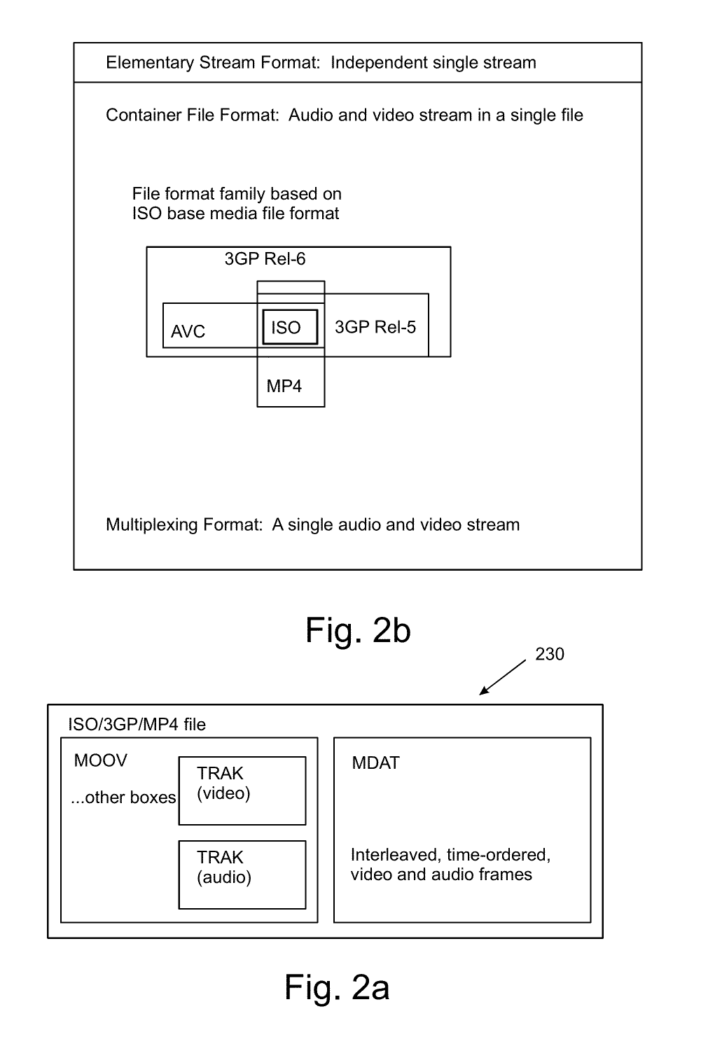

FIG. 2a shows a simplified file structure 230 according to the ISO base media file format. The basic building block in the ISO base media file format is called a box. Each box has a header and a payload. The box header indicates the type of the box and the size of the box in terms of bytes. A box may enclose other boxes, and the ISO file format specifies which box types are allowed within a box of a certain type. Furthermore, some boxes are mandatorily present in each file, while others are optional. Moreover, for some box types, it is allowed to have more than one box present in a file. It may be concluded that the ISO base media file format specifies a hierarchical structure of boxes.

According to ISO family of file formats, a file includes media data and metadata that are enclosed in separate boxes, the media data (mdat) box and the movie (moov) box, respectively. For a file to be operable, both of these boxes should be present, unless media data is located in one or more external files and referred to using the data reference box as described subsequently. The movie box may contain one or more tracks, and each track resides in one track box. A track may be one of the following types: media, hint, timed metadata. A media track refers to samples formatted according to a media compression format (and its encapsulation to the ISO base media file format). A hint track refers to hint samples, containing cookbook instructions for constructing packets for transmission over an indicated communication protocol. The cookbook instructions may contain guidance for packet header construction and include packet payload construction. In the packet payload construction, data residing in other tracks or items may be referenced, i.e. it is indicated by a reference which piece of data in a particular track or item is instructed to be copied into a packet during the packet construction process. A timed metadata track refers to samples describing referred media and/or hint samples. For the presentation one media type, typically one media track is selected.

Samples of a track are implicitly associated with sample numbers that are incremented by 1 in the indicated decoding order of samples. The first sample in a track is associated with sample number 1. It is noted that this assumption affects some of the formulas below, and it is obvious for a person skilled in the art to modify the formulas accordingly for other start offsets of sample number (such as 0).

FIG. 2b shows an example of a simplified file structure according to the ISO base media file format.

Although not illustrated in FIG. 2b, many files formatted according to the ISO base media file format start with a file type box, also referred to as the ftyp box. The ftyp box contains information of the brands labeling the file. The ftyp box includes one major brand indication and a list of compatible brands. The major brand identifies the most suitable file format specification to be used for parsing the file. The compatible brands indicate which file format specifications and/or conformance points the file conforms to. It is possible that a file is conformant to multiple specifications. All brands indicating compatibility to these specifications should be listed, so that a reader only understanding a subset of the compatible brands can get an indication that the file can be parsed. Compatible brands also give a permission for a file parser of a particular file format specification to process a file containing the same particular file format brand in the ftyp box.

It is noted that the ISO base media file format does not limit a presentation to be contained in one file, but it may be contained in several files. One file contains the metadata for the whole presentation. This file may also contain all the media data, whereupon the presentation is self-contained. The other files, if used, are not required to be formatted to ISO base media file format, are used to contain media data, and may also contain unused media data, or other information. The ISO base media file format concerns the structure of the presentation file only. The format of the media-data files is constrained the ISO base media file format or its derivative formats only in that the media-data in the media files is formatted as specified in the ISO base media file format or its derivative formats.

The ability to refer to external files is realized through data references as follows. The sample description box contained in each track includes a list of sample entries, each providing detailed information about the coding type used, and any initialization information needed for that coding. All samples of a chunk and all samples of a track fragment use the same sample entry. A chunk is a contiguous set of samples for one track. The Data Reference box, also included in each track, contains a indexed list of URLs, URNs, and self-references to the file containing the metadata. A sample entry points to one index of the Data Reference box, hence indicating the file containing the samples of the respective chunk or track fragment.

Movie fragments may be used when recording content to ISO files in order to avoid losing data if a recording application crashes, runs out of disk, or some other incident happens. Without movie fragments, data loss may occur because the file format insists that all metadata (the Movie Box) be written in one contiguous area of the file. Furthermore, when recording a file, there may not be sufficient amount of Random Access Memory (RAM) or other read/write memory to buffer a Movie Box for the size of the storage available, and re-computing the contents of a Movie Box when the movie is closed is too slow. Moreover, movie fragments may enable simultaneous recording and playback of a file using a regular ISO file parser. Finally, smaller duration of initial buffering is required for progressive downloading, i.e. simultaneous reception and playback of a file, when movie fragments are used and the initial Movie Box is smaller compared to a file with the same media content but structured without movie fragments.

The movie fragment feature enables to split the metadata that conventionally would reside in the moov box to multiple pieces, each corresponding to a certain period of time for a track. In other words, the movie fragment feature enables to interleave file metadata and media data. Consequently, the size of the moov box may be limited and the use cases mentioned above be realized.

The media samples for the movie fragments reside in an mdat box, as usual, if they are in the same file as the moov box. For the meta data of the movie fragments, however, a moof box is provided. It comprises the information for a certain duration of playback time that would previously have been in the moov box. The moov box still represents a valid movie on its own, but in addition, it comprises an mvex box indicating that movie fragments will follow in the same file. The movie fragments extend the presentation that is associated to the moov box in time.

Within the movie fragment there is a set of track fragments, zero or more per track. The track fragments in turn contain zero or more track runs, each of which document a contiguous run of samples for that track. Within these structures, many fields are optional and can be defaulted.

The metadata that may be included in the moof box is limited to a subset of the metadata that may be included in a moov box and is coded differently in some cases. Details of the boxes that may be included in a moof box may be found from the ISO base media file format specification.

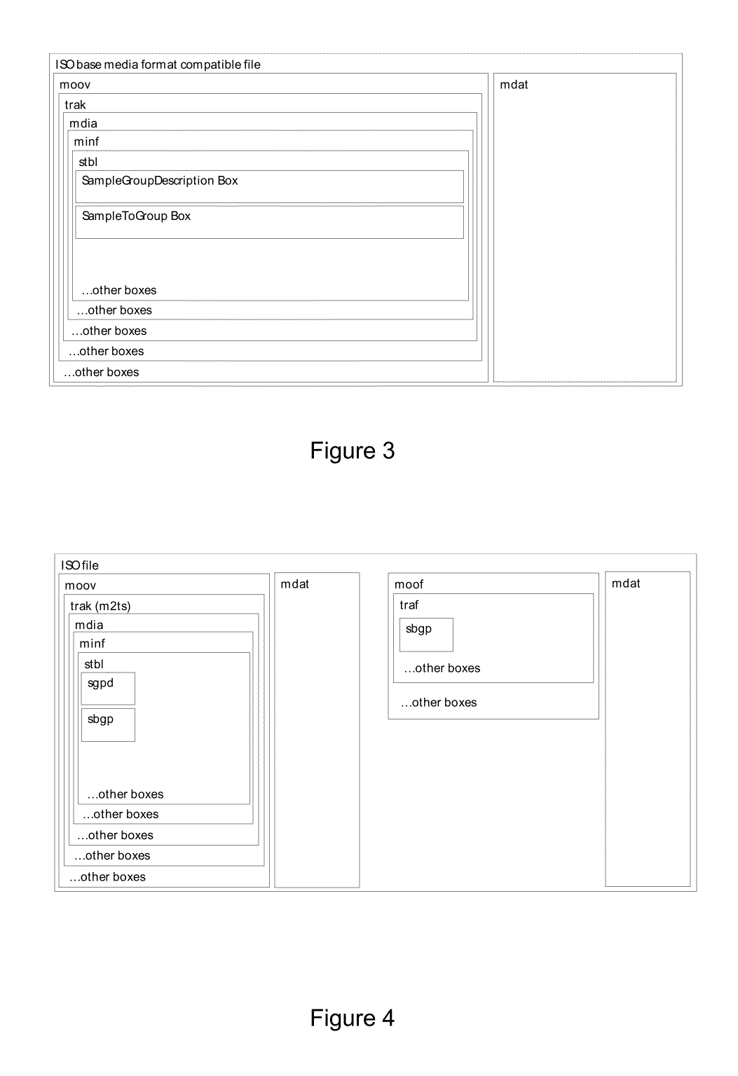

Referring now to FIGS. 3 and 4, the use of sample grouping in boxes is illustrated. A sample grouping in the ISO base media file format and its derivatives, such as the AVC file format and the SVC file format, is an assignment of each sample in a track to be a member of one sample group, based on a grouping criterion. A sample group in a sample grouping is not limited to being contiguous samples and may contain non-adjacent samples. As there may be more than one sample grouping for the samples in a track, each sample grouping has a type field to indicate the type of grouping. Sample groupings are represented by two linked data structures: (1) a SampleToGroup box (sbgp box) represents the assignment of samples to sample groups; and (2) a SampleGroupDescription box (sgpd box) contains a sample group entry for each sample group describing the properties of the group. There may be multiple instances of the SampleToGroup and SampleGroupDescription boxes based on different grouping criteria. These are distinguished by a type field used to indicate the type of grouping.

FIG. 3 provides a simplified box hierarchy indicating the nesting structure for the sample group boxes. The sample group boxes (SampleGroupDescription Box and SampleToGroup Box) reside within the sample table (stbl) box, which is enclosed in the media information (minf), media (mdia), and track (trak) boxes (in that order) within a movie (moov) box.

The SampleToGroup box is allowed to reside in a movie fragment. Hence, sample grouping may be done fragment by fragment. FIG. 4 illustrates an example of a file containing a movie fragment including a SampleToGroup box. In the draft Amendment 3 of the ISO Base Media File Format (Edition 3), it is allowed to include the SampleGroupDescription Box to reside in movie fragments in addition to the sample table box.

Multi-level temporal scalability hierarchies enabled by H.264/AVC, SVC, and MVC are suggested to be used due to their significant compression efficiency improvement. However, the multi-level hierarchies also cause a significant delay between starting of the decoding and starting of the rendering. The delay is caused by the fact that decoded pictures have to be reordered from their decoding order to the output/display order. Consequently, when accessing a stream from a random position, the start-up delay is increased, and similarly the tune-in delay to a multicast or broadcast is increased compared to those of non-hierarchical temporal scalability.

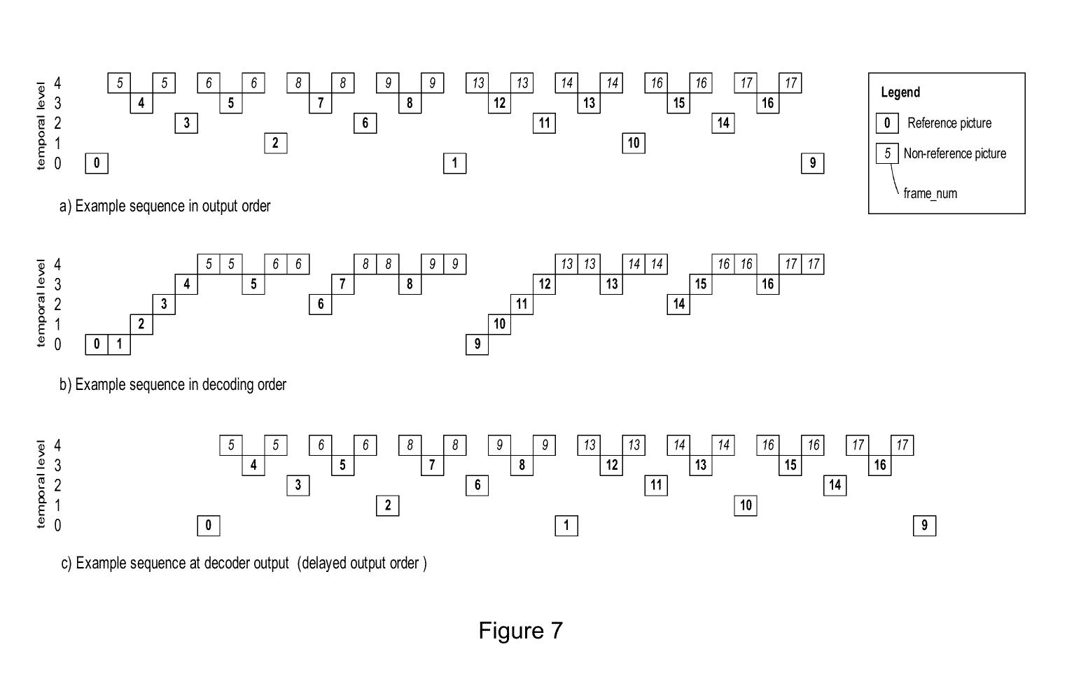

FIGS. 7a-7c illustrate an example of a hierarchically scalable bitstream with five temporal levels (a.k.a. GOP size 16). Pictures at temporal level 0 are predicted from the previous picture(s) at temporal level 0. Pictures at temporal level N (N>0) are predicted from the previous and subsequent pictures in output order at temporal level <N. It is assumed in this example that decoding of one picture lasts one picture interval. Even though this is a naïve assumption, it serves the purpose of illustrating the problem without loss of generality.

FIG. 7a shows the example sequence in output order. Values enclosed in boxes indicate the frame_num value of the picture. Values in italics indicate a non-reference picture while the other pictures are reference pictures.

FIG. 7b shows the example sequence in decoding order. FIG. 7c shows the example sequence in output order when assuming that the output timeline coincides with that of the decoding timeline. From FIG. 7a it can be seen that the picture having the frame number 5 should be decoded before the sequence can be correctly decoded and output. Therefore, the output of the sequence is delayed five frame intervals in FIG. 7c so that outputting the rest of the sequence would not cause any gaps at decoder output. In other words, in FIG. 7c the earliest output time of a picture is in the next picture interval following the decoding of the picture. It can be seen that playback of the stream starts five picture intervals later than the decoding of the stream started. If the pictures were sampled at 25 Hz, the picture interval is 40 msec, and the playback is delayed by 0.2 sec.

The AVC File Format (ISO/IEC 14496-15) is based on the ISO Base Media File Format. It describes how to store H.264/AVC streams in any file format based on the ISO Base Media File Format.

An AVC stream is a sequence of access units, each divided into a number of Network Abstraction Layer (NAL) units. In an AVC file, all NAL units of an access unit form a file format sample, and, in the file, each NAL unit is immediately preceded by its size in bytes.

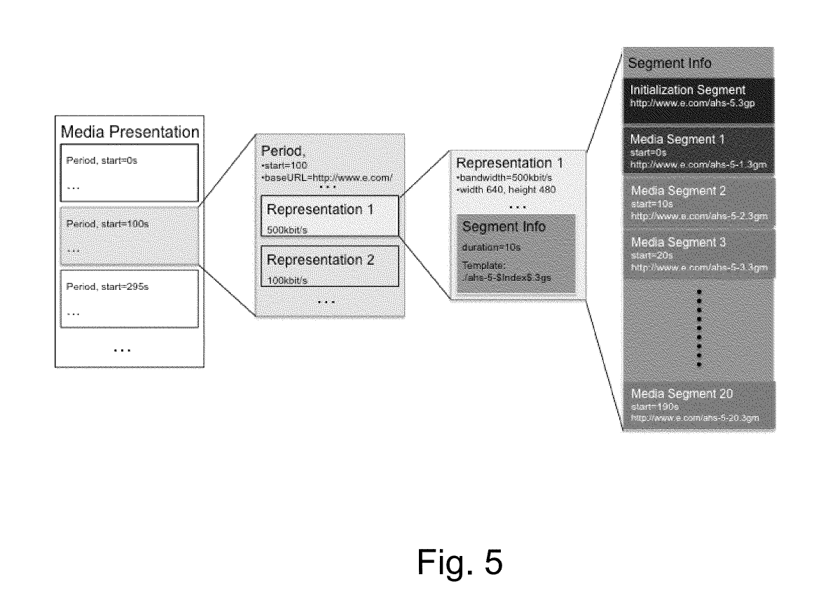

An example of the structure of an AVC sample is depicted in FIG. 5.

An AVC access unit is made up of a set of NAL units. Each NAL unit is represented with a length field (Length) and the payload (NAL Unit). Length indicates the length in bytes of the following NAL unit. The length field can be configured to be of 1, 2, or 4 bytes. The NAL Unit contains the NAL unit data as specified in ISO/IEC 14496-10.

The SVC and MVC File Formats are further specializations of the AVC File Format, and compatible with it. Like the AVC File Format, they define how SVC and MVC streams are stored within any file format based on the ISO Base Media File Format.

Since the SVC and MVC codecs can be operated in a way that is compatible with AVC, the SVC and MVC File Formats can also be used in an AVC-compatible fashion. However, there are some SVC- and MVC-specific structures to enable scalable and multiview operation.

A sample, such as a picture for a video track, in ISO Base Media File Format compliant files is typically associated with a decoding time indicating when its processing or decoding is started, and a composition time indicating when the sample are rendered or output. Composition times are specific to their track, e.g., they appear on the media timeline of the track. Composition times are indicated through offsets between decoding times and respective composition times. The composition offsets are included in the Composition Time to Sample box for samples that are described in the Sample Table box and in the movie fragment structures, such as the Track Run box, for samples that are described in the Track Fragment boxes. Since Amendment 1 of the ISO Base Media File Format (Edition 3), the composition offsets have been allowed to be signed, whereas in earlier releases of the file format specification the composition offsets were required to be non-negative. The synchronization of the tracks relative to each other may be indicated through Edit Boxes, each of which contains a mapping of the media timeline of the track containing the Edit Box to the movie timeline. An Edit Box includes an Edit List Box, which contains a sequence of operations or instructions, each mapping a section of the media timeline to the movie timeline. An instruction known as an empty edit may be used shift the start time of the media timeline such that it starts at a non-zero position on the movie timeline.

A composition to decode box can be defined as follows:

Box Type: ‘cslg’
Container: Sample Table Box (‘stbl’) or Track Extension Properties Box (‘trep’)

### Mandatory: No

### Quantity: Zero or one

When signed composition offsets are used, this box may be used to relate the composition and decoding timelines, and deal with some of the ambiguities that signed composition offsets introduce.

All these fields may apply to the entire media (not just that selected by any edits). It is recommended that any edits, explicit or implied, not select any portion of the composition timeline that does not map to a sample. For example, if the smallest composition time is 1000, then the default edit from 0 to the media duration leaves the period from 0 to 1000 associated with no media sample. Player behaviour, and what is composed in this interval, is undefined under these circumstances. It is recommended that the smallest computed composition timestamp (CTS) be zero, or match the beginning of the first edit.

When the Composition to Decode Box is included in the Sample Table Box, it documents the composition and decoding time relations of the samples in the Movie Box. When the Composition to Decode Box is included in the Track Extension Properties Box, it documents the composition and decoding time relations of the samples in all movie fragments following the Movie Box.

The composition duration of the last sample in a track might be ambiguous or unclear; the field for composition end time can be used to clarify this ambiguity and, with the composition start time, establish a clear composition duration for the track. However, since the composition end time might be unknown when the box documents movie fragments, the presence of the composition end time is optional.

A syntax of the composition to decode box can be defined as follows:

class CompositionToDecodeBox extends FullBox(‘cslg’, version, flags) {

| | |
|---|---|
| signed int(32) | compositionToDTSShift; |
| signed int(32) | leastDecodeToDisplayDelta; |
| signed int(32) | greatestDecodeToDisplayDelta; |
| signed int(32) | compositionStartTime; |

if ((flags & 1) == 0)

| | |
|---|---|
| signed int(32) | compositionEndTime; |

}

If the value compositionToDTSShift is added to the composition times (as calculated by the CTS offsets from the decoding timestamp, DTS), then for all samples, their CTS is guaranteed to be greater than or equal to their DTS, and the buffer model implied by the indicated profile/level will be honored; if leastDecodeToDisplayDelta is positive or zero, this field can be 0. Otherwise this field should be at least (−leastDecodeToDisplayDelta).

leastDecodeToDisplayDelta: the smallest composition offset in the CompositionTimeToSample box in this track

greatestDecodeToDisplayDelta: the largest composition offset in the CompositionTimeToSample box in this track

compositionStartTime: the smallest computed composition time (CTS) for any sample in the media of this track

compositionEndTime: the composition time plus the composition duration, of the sample with the largest computed composition time (CTS) in the media of this track

Track Extension Properties Box can be defined as follows:

Box Type: ‘trep’
Container: Movie Extends Box (‘mvex’)

### Mandatory: No

Quantity: Zero or more. (Zero or one per track)

This box can be used to document or summarize characteristics of the track in the subsequent movie fragments. It may contain any number of child boxes.

The syntax of the Track Extension Properties Box can be defined as follows:

```
class TrackExtensionPropertiesBox extends FullBox(‘trep’, 0, 0) {
  unsigned int(32) track id;
  // Any number of boxes may follow
}
```

track_id indicates the track for which the track extension properties are provided in this box.

An alternative startup sequence contains a subset of samples of a track within a certain period starting from a sync sample. By decoding this subset of samples, the rendering of the samples can be started earlier than in the case when all samples are decoded.

An ‘alst’ sample group description entry indicates the number of samples in any of the respective alternative startup sequences, after which all samples should be processed.

Either version 0 or version 1 of the Sample to Group Box may be used with the alternative startup sequence sample grouping. If version 1 of the Sample to Group Box is used, grouping_type_parameter has no defined semantics but the same algorithm to derive alternative startup sequences may be used consistently for a particular value of grouping_type_parameter.

A player utilizing alternative startup sequences could operate as follows. First, a sync sample from which to start decoding is identified by using the Sync Sample Box. Then, if the sync sample is associated to a sample group description entry of type ‘alst’ where roll_count is greater than 0, the player can use the alternative startup sequence. The player then decodes only those samples that are mapped to the alternative startup sequence until the number of samples that have been decoded is equal to roll_count. After that, all samples may be decoded.

The syntax of the alternative startup sequence may be as follows:

```
class AlternativeStartupEntry( ) extends VisualSampleGroupEntry (’alst’)
{
  unsigned int(16) roll_count;
  unsigned int(16) first_output_sample;
  for (i=1; i <= roll_count; i++)
    unsigned int(32) sample_offset[i];
  j=1;
  do { // optional, until the end of the structure
    unsigned int(16) num_output_samples[j];
    unsigned int(16) num_total_samples[j];
    j++;
  }
}
```

roll_count indicates the number of samples in the alternative startup sequence. If roll_count is equal to 0, the associated sample does not belong to any alternative startup sequence and the semantics of first_output_sample are unspecified. The number of samples mapped to this sample group entry per one alternative startup sequence is equal to roll_count.

first_output_sample indicates the index of the first sample intended for output among the samples in the alternative startup sequence. The index is of the sync sample starting the alternative startup sequence is 1, and the index is incremented by 1, in decoding order, per each sample in the alternative startup sequence.

sample_offset[i] indicates the decoding time delta of the i-th sample in the alternative startup sequence relative to the regular decoding time of the sample derived from the Decoding Time to Sample Box or the Track Fragment Header Box. The sync sample starting the alternative startup sequence is its first sample.

num_output_samples[j] and num_total_samples[j] indicate the sample output rate within the alternative startup sequence. The alternative startup sequence is divided into k consecutive pieces, where each piece has a constant sample output rate which is unequal to that of the adjacent pieces. The first piece starts from the sample indicated by first_output_sample. num_output_samples[j] indicates the number of the output samples of the j-th piece of the alternative startup sequence. num_total_samples[j] indicates the total number of samples, including those that are not in the alternative startup sequence, from the first sample in the j-th piece that is output to the earlier one (in composition order) of the sample that ends the alternative startup sequence and the sample that immediately precedes the first output sample of the (j+1)th piece.

Alternatively or in addition to sync samples, samples marked with the ‘rap’ sample grouping specified in the draft Amendment 3 of the ISO Base Media File Format (Edition 3) could be used above.

Hierarchical temporal scalability (e.g., in AVC and SVC) may improve compression efficiency but may increase the decoding delay due to reordering of the decoded pictures from the (de)coding order to output order. Deep temporal hierarchies have been demonstrated to be useful in terms of compression efficiency in some studies. When the temporal hierarchy is deep and the operation speed of the decoder is limited (to no faster than real-time processing), the initial delay from the start of the decoding to the start of rendering may be substantial and may affect the end-user experience negatively.

An Alternative Startup Sequence Properties Box can be defined as follows:

Box Type: ‘assp’
Container: Track Extension Properties Box (‘trep’)

### Mandatory: No

### Quantity: Zero or one

This box indicates the properties of alternative startup sequence sample groups in the subsequent track fragments of the track indicated in the containing Track Extension Properties box.

Version 0 of the Alternative Startup Sequence Properties box can be used if version 0 of the Sample to Group box is used for the alternative startup sequence sample grouping. Version 1 of the Alternative Startup Sequence Properties box can be used if version 1 of the Sample to Group box is used for the alternative startup sequence sample grouping.

The syntax of the Alternative Startup Sequence Properties Box can be defined as follows:

class AlternativeStartupSequencePropertiesBox extends FullBox(‘assp’, version, 0) {
if (version == 0) {

| | |
|---|---|
| signed int(32) | min_initial_alt_startup_offset; |

```
  }
  else if (version == 1) {
```

| | |
|---|---|
| unsigned int(32) | num_entries; |

for (j=1; j <= num_entries; j++) {

| | |
|---|---|
| unsigned int(32) | grouping_type_parameter; |
| signed int(32) | min_initial_alt_startup_offset; |

```
    }
  }
}
```

min_initial_alt_startup_offset: No value of sample_offset[1] of the referred sample group description entries of the alternative startup sequence sample grouping is smaller than min_initial_alt_startup_offset. In version 0 of this box, the alternative startup sequence sample grouping using version 0 of the Sample to Group box is referred to. In version 1 of this box, the alternative startup sequence sample grouping using version 1 of the Sample to Group box is referred to as further constrained by grouping_type_parameter.

num_entries indicates the number of alternative startup sequence sample groupings documented in this box.

grouping_type_parameter indicates which one of the alternative sample groupings this loop entry applies to.

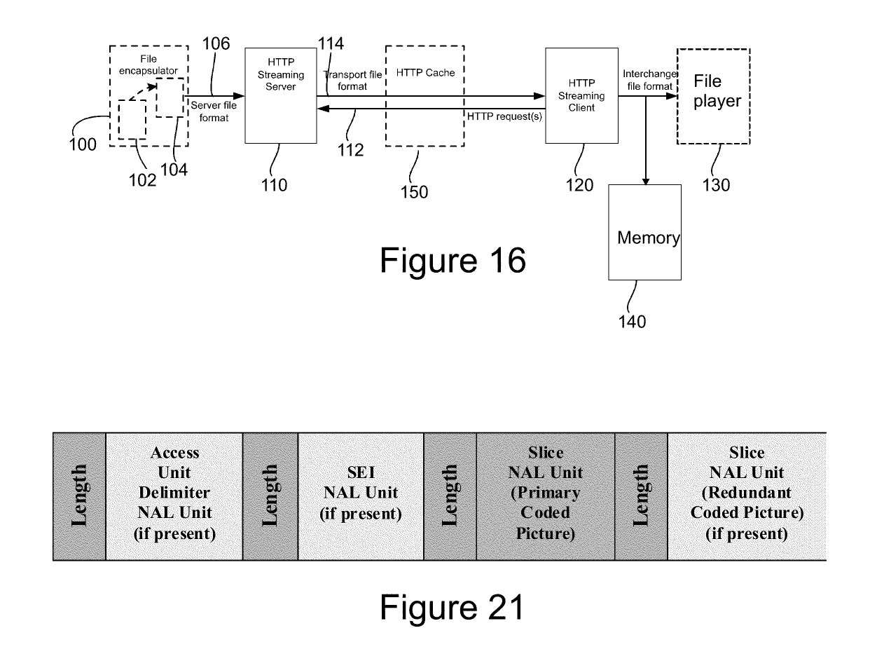

In FIG. 16 an example illustration of some functional blocks, formats, and interfaces included in a hypertext transfer protocol (HTTP) streaming system are shown. A file encapsulator 100 takes media bitstreams of a media presentation as input. The bitstreams may already be encapsulated in one or more container files 102. The bitstreams may be received by the file encapsulator 100 while they are being created by one or more media encoders. The file encapsulator converts the media bitstreams into one or more files 104, which can be processed by a streaming server 110 such as the HTTP streaming server. The output 106 of the file encapsulator is formatted according to a server file format. The HTTP streaming server 110 may receive requests from a streaming client 120 such as the HTTP streaming client. The requests may be included in a message or messages according to e.g. the hypertext transfer protocol such as a GET request message. The request may include an address indicative of the requested media stream. The address may be the so called uniform resource locator (URL). The HTTP streaming server 110 may respond to the request by transmitting the requested media file(s) and other information such as the metadata file(s) to the HTTP streaming client 120. The HTTP streaming client 120 may then convert the media file(s) to a file format suitable for play back by the HTTP streaming client and/or by a media player 130. The converted media data file(s) may also be stored into a memory 140 and/or to another kind of storage medium. The HTTP streaming client and/or the media player may include or be operationally connected to one or more media decoders, which may decode the bitstreams contained in the HTTP responses into a format that can be rendered.

Server File Format

A server file format is used for files that the HTTP streaming server 110 manages and uses to create responses for HTTP requests. There may be, for example, the following three approaches for storing media data into file(s).

In a first approach a single metadata file is created for all versions. The metadata of all versions (e.g. for different bitrates) of the content (media data) resides in the same file. The media data may be partitioned into fragments covering certain playback ranges of the presentation. The media data can reside in the same file or can be located in one or more external files referred to by the metadata.

In a second approach one metadata file is created for each version. The metadata of a single version of the content resides in the same file. The media data may be partitioned into fragments covering certain playback ranges of the presentation. The media data can reside in the same file or can be located in one or more external files referred to by the metadata.

In a third approach one file is created per each fragment. The metadata and respective media data of each fragment covering a certain playback range of a presentation and each version of the content resides in their own files. Such chunking of the content to a large set of small files may be used in a possible realization of static HTTP streaming. For example, chunking of a content file of duration 20 minutes and with 10 possible representations (5 different video bitrates and 2 different audio languages) into small content pieces of 1 second, would result in 12000 small files. This constitutes a burden on web servers, which has to deal with such a large amount of small files.

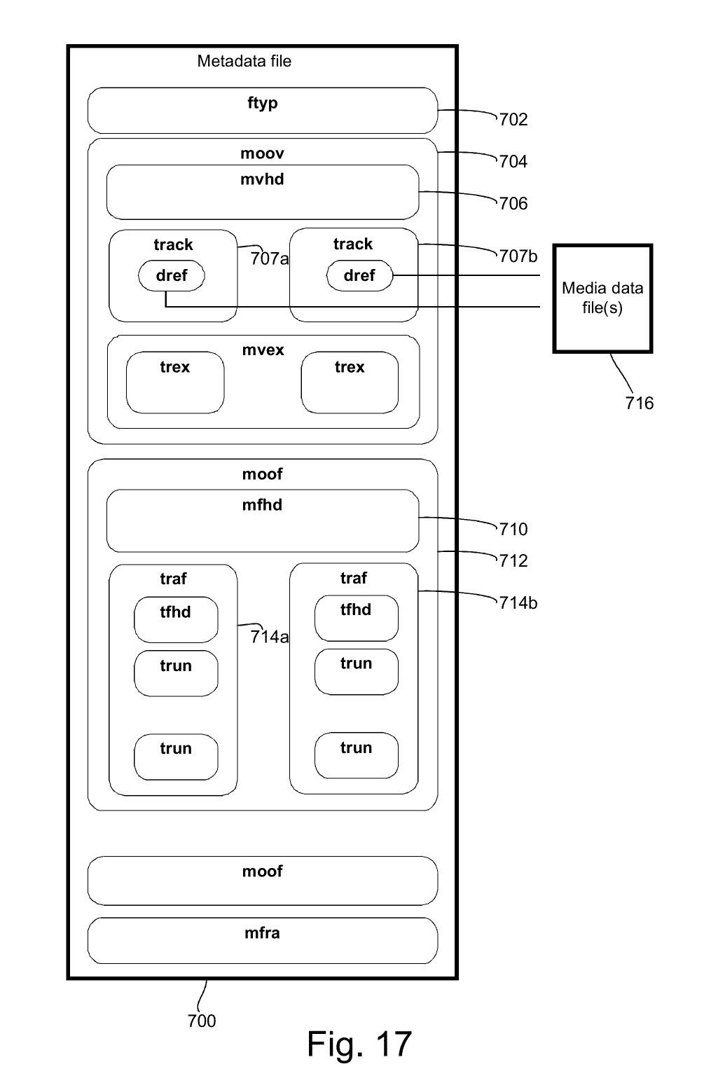

The first and the second approach i.e. a single metadata file for all versions and one metadata file for each version, respectively, are illustrated in FIG. 17 using the structures of the ISO base media file format. In the example of FIG. 17, the metadata is stored separately from the media data, which is stored in external file(s). The metadata is partitioned into fragments 707a, 714a; 707b, 714b covering a certain playback duration. If the file contains tracks 707a, 707b that are alternatives to each other, such as the same content coded with different bitrates, FIG. 17 illustrates the case of a single metadata file for all versions; otherwise, it illustrates the case of one metadata file for each version.

HTTP Streaming Server

A HTTP streaming server 110 takes one or more files of a media presentation as input. The input files are formatted according to a server file format. The HTTP streaming server 110 responds 114 to HTTP requests 112 from a HTTP streaming client 120 by encapsulating media in HTTP responses. The HTTP streaming server outputs and transmits a file or many files of the media presentation formatted according to a transport file format and encapsulated in HTTP responses.

In some embodiments the HTTP streaming servers 110 can be coarsely categorized into three classes. The first class is a web server, which is also known as a HTTP server, in a “static” mode. In this mode, the HTTP streaming client 120 may request one or more of the files of the presentation, which may be formatted according to the server file format, to be transmitted entirely or partly. The server is not required to prepare the content by any means. Instead, the content preparation is done in advance, possibly offline, by a separate entity.

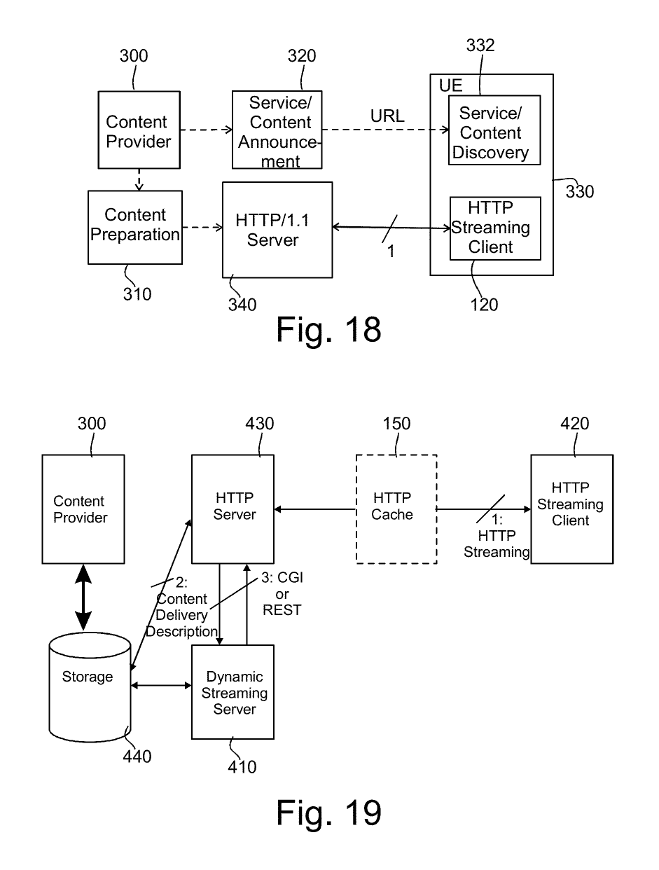

FIG. 18 illustrates an example of a web server as a HTTP streaming server. A content provider 300 may provide a content for content preparation 310 and an announcement of the content to a service/content announcement service 320. The user device 330, which may contain the HTTP streaming client 120, may receive information regarding the announcements from the service/content announcement service 320 wherein the user of the user device 330 may select a content for reception. The service/content announcement service 320 may provide a web interface and consequently the user device 330 may select a content for reception through a web browser in the user device 330. Alternatively or in addition, the service/content announcement service 320 may use other means and protocols such as the Service Advertising Protocol (SAP), the Really Simple Syndication (RSS) protocol, or an Electronic Service Guide (ESG) mechanism of a broadcast television system. The user device 330 may contain a service/content discovery element 332 to receive information relating to services/contents and e.g. provide the information to a display of the user device. The streaming client 120 may then communicate with the web server 340 to inform the web server 340 of the content the user has selected for downloading. The web server 340 may then fetch the content from the content preparation service 310 and provide the content to the HTTP streaming client 120.

The second class is a (regular) web server operationally connected with a dynamic streaming server as illustrated in FIG. 19. The dynamic streaming server 410 dynamically tailors the streamed content to a client 420 based on requests from the client 420. The HTTP streaming server 430 interprets the HTTP GET request from the client 420 and identifies the requested media samples from a given content. The HTTP streaming server 430 then locates the requested media samples in the content file(s) or from the live stream. It then extracts and envelopes the requested media samples in a container 440. Subsequently, the newly formed container with the media samples is delivered to the client in the HTTP GET response body.

The first interface “1” in FIGS. 18 and 19 is based on the HTTP protocol and defines the syntax and semantics of the HTTP Streaming requests and responses. The HTTP Streaming requests/responses may be based on the HTTP GET requests/responses.

The second interface “2” in FIG. 19 enables access to the content delivery description. The content delivery description, which may also be called as a media presentation description, may be provided by the content provider 450 or the service provider. It gives information about the means to access the related content. In particular, it describes if the content is accessible via HTTP Streaming and how to perform the access. The content delivery description is usually retrieved via HTTP GET requests/responses but may be conveyed by other means too, such as by using SAP, RSS, or ESG.

The third interface “3” in FIG. 19 represents the Common Gateway Interface (CGI), which is a standardized and widely deployed interface between web servers and dynamic content creation servers. Other interfaces such as a representational State Transfer (REST) interface are possible and would enable the construction of more cache-friendly resource locators.

The Common Gateway Interface (CGI) defines how web server software can delegate the generation of web pages to a console application. Such applications are known as CGI scripts; they can be written in any programming language, although scripting languages are often used. One task of a web server is to respond to requests for web pages issued by clients, usually web browsers, by analyzing the content of the request, determining an appropriate document to send in response, and providing the document to the client. If the request identifies a file on disk, the server can return the contents of the file. Alternatively, the content of the document can be composed on the fly. One way of doing this is to let a console application compute the document's contents, and inform the web server to use that console application. CGI specifies which information is communicated between the web server and such a console application, and how.

The representational State Transfer is a style of software architecture for distributed hypermedia systems such as the World Wide Web (WWW). REST-style architectures consist of clients and servers. Clients initiate requests to servers; servers process requests and return appropriate responses. Requests and responses are built around the transfer of “representations” of “resources”. A resource can be essentially any coherent and meaningful concept that may be addressed. A representation of a resource may be a document that captures the current or intended state of a resource. At any particular time, a client can either be transitioning between application states or at rest. A client in a rest state is able to interact with its user, but creates no load and consumes no per-client storage on the set of servers or on the network. The client may begin to send requests when it is ready to transition to a new state. While one or more requests are outstanding, the client is considered to be transitioning states. The representation of each application state contains links that may be used next time the client chooses to initiate a new state transition.

The third class of the HTTP streaming servers according to this example classification is a dynamic HTTP streaming server. Otherwise similar to the second class, but the HTTP server and the dynamic streaming server form a single component. In addition, a dynamic HTTP streaming server may be state-keeping.

Server-end solutions can realize HTTP streaming in two modes of operation: static HTTP streaming and dynamic HTTP streaming. In the static HTTP streaming case, the content is prepared in advance or independent of the server. The structure of the media data is not modified by the server to suit the clients' needs. A regular web server in “static” mode can only operate in static HTTP streaming mode. In the dynamic HTTP streaming case, the content preparation is done dynamically at the server upon receiving a non-cached request. A regular web server operationally connected with a dynamic streaming server and a dynamic HTTP streaming server can be operated in the dynamic HTTP streaming mode.

Transport File Format, May Also be Referred to as Delivery Format, Delivery File Format, or Segment Format.

In an example embodiment transport file formats can be coarsely categorized into two classes. In the first class transmitted files are compliant with an existing file format that can be used for file playback. For example, transmitted files are compliant with the ISO Base Media File Format or the progressive download profile of the 3GPP file format.

In the second class transmitted files are similar to files formatted according to an existing file format used for file playback. For example, transmitted files may be fragments of a server file, which might not be self-containing for playback individually. In another approach, files to be transmitted are compliant with an existing file format that can be used for file playback, but the files are transmitted only partially and hence playback of such files requires awareness and capability of managing partial files.

Transmitted files can usually be converted to comply with an existing file format used for file playback.

HTTP Cache

An HTTP cache 150 (FIG. 16) may be a regular web cache that stores HTTP requests and responses to the requests to reduce bandwidth usage, server load, and perceived lag. If an HTTP cache contains a particular HTTP request and its response, it may serve the requestor instead of the HTTP streaming server.

HTTP Streaming Client

An HTTP streaming client 120 receives the file(s) of the media presentation. The HTTP streaming client 120 may contain or may be operationally connected to a media player 130 which parses the files, decodes the included media streams and renders the decoded media streams. The media player 130 may also store the received file(s) for further use. An interchange file format can be used for storage.

In some example embodiments the HTTP streaming clients can be coarsely categorized into at least the following two classes. In the first class conventional progressive downloading clients guess or conclude a suitable buffering time for the digital media files being received and start the media rendering after this buffering time. Conventional progressive downloading clients do not create requests related to bitrate adaptation of the media presentation.

In the second class active HTTP streaming clients monitor the buffering status of the presentation in the HTTP streaming client and may create requests related to bitrate adaptation in order to guarantee rendering of the presentation without interruptions.

The HTTP streaming client 120 may convert the received HTTP response payloads formatted according to the transport file format to one or more files formatted according to an interchange file format. The conversion may happen as the HTTP responses are received, i.e. an HTTP response is written to a media file as soon as it has been received. Alternatively, the conversion may happen when multiple HTTP responses up to all HTTP responses for a streaming session have been received.

Interchange File Formats

In some example embodiments the interchange file formats can be coarsely categorized into at least the following two classes. In the first class the received files are stored as such according to the transport file format.

In the second class the received files are stored according to an existing file format used for file playback.

A Media File Player

A media file player 130 may parse, decode, and render stored files. A media file player 130 may be capable of parsing, decoding, and rendering either or both classes of interchange files. A media file player 130 is referred to as a legacy player if it can parse and play files stored according to an existing file format but might not play files stored according to the transport file format. A media file player 130 is referred to as an HTTP streaming aware player if it can parse and play files stored according to the transport file format.

In some implementations, an HTTP streaming client merely receives and stores one or more files but does not play them. In contrast, a media file player parses, decodes, and renders these files while they are being received and stored.

In some implementations, the HTTP streaming client 120 and the media file player 130 are or reside in different devices. In some implementations, the HTTP streaming client 120 transmits a media file formatted according to a interchange file format over a network connection, such as a wireless local area network (WLAN) connection, to the media file player 130, which plays the media file. The media file may be transmitted while it is being created in the process of converting the received HTTP responses to the media file. Alternatively, the media file may be transmitted after it has been completed in the process of converting the received HTTP responses to the media file. The media file player 130 may decode and play the media file while it is being received. For example, the media file player 130 may download the media file progressively using an HTTP GET request from the HTTP streaming client. Alternatively, the media file player 130 may decode and play the media file after it has been completely received.

HTTP pipelining is a technique in which multiple HTTP requests are written out to a single socket without waiting for the corresponding responses. Since it may be possible to fit several HTTP requests in the same transmission packet such as a transmission control protocol (TCP) packet, HTTP pipelining allows fewer transmission packets to be sent over the network, which may reduce the network load.

A connection may be identified by a quadruplet of server IP address, server port number, client IP address, and client port number. Multiple simultaneous TCP connections from the same client to the same server are possible since each client process is assigned a different port number. Thus, even if all TCP connections access the same server process (such as the Web server process at port 80 dedicated for HTTP), they all have a different client socket and represent unique connections. This is what enables several simultaneous requests to the same Web site from the same computer.

Some third and future generation wireless technologies build upon evolved GSM (Global System for Mobile communications) core networks and the radio access technologies that they support.

Some elements and concepts defined by the Dynamic Adaptive HTTP Streaming standard (DASH) are described below.

A Media Presentation is a structured collection of encoded data of a single media content, e.g. a movie or a program. The data is accessible to the HTTP-Streaming Client to provide a streaming service to the user. A media presentation consists of a sequence of one or more consecutive non-overlapping periods; each period contains one or more representations from the same media content; each representation consists of one or more segments; and segments contain media data and/or metadata to decode and present the included media content.

Period boundaries permit to change a significant amount of information within a media presentation such as a server location, encoding parameters, or the available variants of the content. The period concept is introduced among others for splicing of a new content, such as advertisements and logical content segmentation. Each period is assigned a start time, relative to start of the media presentation.

Each period itself may consist of one or more representations. A representation is one of the alternative choices of the media content or a subset thereof differing e.g. by the encoding choice, for example by bitrate, resolution, language, codec, etc.

Each representation includes one or more media components where each media component is an encoded version of one individual media type such as audio, video or timed text. Each representation is assigned to an adaptation set. Representations in the same adaptation set are alternatives to each other, e.g., a client may switch between representations in the same adaptation set, for example based on bitrates of representations, an estimated available throughput, and a buffer occupancy in the client.

A representation may contain one initialisation segment and one or more media segments. Media components are time-continuous across boundaries of consecutive media segments within one representation. Segments represent a unit that can be uniquely referenced by an http-URL (possibly restricted by a byte range). Thereby, the initialisation segment contains information for accessing the representation, but no media data. Media segments contain media data and they may fulfill some further requirements which may contain one or more of the following examples:
Each media segment is assigned a start time in the media presentation to enable downloading the appropriate segments in regular play-out mode or after seeking. This time is generally not accurate media playback time, but only approximate such that the client can make appropriate decisions on when to download the segment such that it is available in time for play-out.
Media segments may provide random access information, i.e. presence, location and timing of Random Access Points.
A media segment, when considered in conjunction with the information and structure of a media presentation description (MPD), contains sufficient information to time-accurately present each contained media component in the representation without accessing any previous media segment in this representation provided that the media segment contains a random access point (RAP). The time-accuracy enables seamlessly switching representations and jointly presenting multiple representations.
Media segments may also contain information for randomly accessing subsets of the Segment by using partial HTTP GET requests.

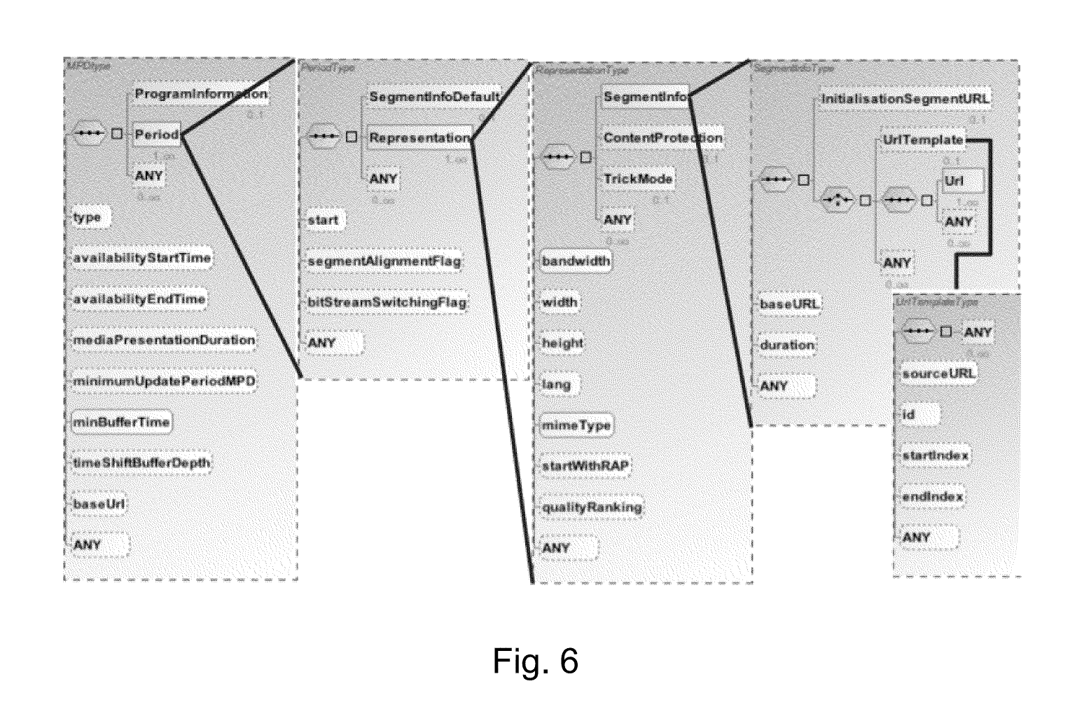

A media presentation is described in a media presentation description (MPD), and the media presentation description may be updated during the lifetime of a media presentation. In particular, the media presentation description describes accessible segments and their timing. The media presentation description may be a well-formatted extensible markup language (XML) document. Different versions of the XML schema and semantics of a media presentation description have been specified in the 3GPP Release 9 Adaptive HTTP Streaming specification (3GPP Technical Specification 26.234 Release 9, Clause 12), 3GPP Release 10, and beyond, Dynamic Adaptive Streaming over HTTP (DASH) specification (3GPP Technical Specification 26.247), and MPEG DASH specification. A media presentation description may be updated in specific ways such that an update is consistent with the previous instance of the media presentation description for any past media. An example of a graphical presentation of the XML schema is provided in FIG. 6. The mapping of the data model to the XML schema is highlighted. The details of the individual attributes and elements may vary in different embodiments.

Adaptive HTTP streaming supports live streaming services. In this case, the generation of segments may happens on-the-fly. Due to this clients may have access to only a subset of the segments, i.e. the current media presentation description describes a time window of accessible segments for this instant-in-time. By providing updates of the media presentation description, the server may describe new segments and/or new periods such that the updated media presentation description is compatible with the previous media presentation description.

Therefore, for live streaming services a media presentation may be described by the initial media presentation description and all media presentation description updates. To ensure synchronization between client and server, the media presentation description provides access information in a coordinated universal time (UTC time). As long as the server and the client are synchronized to the UTC time, the synchronization between server and client is possible by the use of the UTC times in the media presentation description instances.

Time-shift viewing and network personal video recording (PVR) functionality are supported as segments may be accessible on the network over a long period of time.

The segment index box, which may be available at the beginning of a segment, can assist in the switching operation. The segment index box is specified as follows.

Box Type: ‘sidx’

### Container: File

### Mandatory: No

Quantity: Zero or more

The segment index box (‘sidx’) provides a compact index of the movie fragments and other segment index boxes in a segment. Each segment index box documents a subsegment, which is defined as one or more consecutive movie fragments, ending either at the end of the containing segment, or at the beginning of a subsegment documented by another segment index box.

The indexing may refer directly to movie fragments, or to segment indexes which, directly or indirectly, refer to movie fragments; the segment index may be specified in a ‘hierarchical’ or ‘daisy-chain’ or other form by documenting time and byte offset information for other segment index boxes within the same segment or subsegment.

There are two loop structures in the segment index box. The first loop documents the first sample of the subsegment, that is, the sample in the first movie fragment referenced by the second loop. The second loop provides an index of the subsegment.

In media segments not containing a Movie Box (‘moov’) but containing Movie Fragment Boxes (‘moof’), if any segment index boxes are supplied then a segment index box should be placed before any Movie Fragment (‘moof’) box, and the subsegment documented by that first Segment Index box is the entire segment.

One track, normally a track in which not every sample is a random access point, such as video, is selected as a reference track. The decoding time of the first sample in the sub-segment of at least the reference track, is supplied. The decoding times in that sub-segment of the first samples of other tracks may also be supplied.

The reference type defines whether the reference is to a Movie Fragment (‘moof’) Box or Segment Index (‘sidx’) Box. The offset gives the distance, in bytes, from the first byte following the enclosing segment index box, to the first byte of the referenced box, e.g., if the referenced box immediately follows the ‘sidx’, this byte offset value is 0.

The decoding time, for the reference track, of the first referenced box in the second loop is the decoding_time given in the first loop. The decoding times of subsequent entries in the second loop are calculated by adding the durations of the preceding entries to this decoding_time. The duration of a track fragment is the sum of the decoding durations of its samples (the decoding duration of a sample is defined explicitly or by inheritance by the sample_duration field of the track run (‘trun’) box); the duration of a sub-segment is the sum of the durations of the track fragments; the duration of a segment index is the sum of the durations in its second loop. The duration of the first segment index box in a segment is therefore the duration of the entire segment.

A segment index box contains a random access point (RAP) if any entry in their second loop contains a random access point.

The decoding time documented for all tracks by the first segment index box after a movie box ‘moov’ should be 0.

The container for ‘sidx’ box is the file or segment directly. In the following an example of a container for the ‘sidx’ box is illustrated by using a pseudo code:

```
aligned(8) class SegmentIndexBox extends FullBox(‘sidx’, version, 0) {
  unsigned int(32) reference_track_ID;
  unsigned int(16) track_count;
  unsigned int(16) reference_count;
  for (i=1; i<= track_count; i++)
  {
```

| | |
|---|---|
| unsigned int(32) | track ID; |

```
    if (version==0)
    {
```

| | |
|---|---|
| unsigned int(32) | decoding_time; |

```
    }else
    {
```

| | |
|---|---|
| unsigned int(64) | decoding_time; |

```
    }
  }
  for(i=1; i <= reference_count; i++)
  {
```

| | |
|---|---|
| bit (1) | reference_t ype; |

| | |
|---|---|
| unsigned int(31) | reference_offset; |
| unsigned int(32) | subsegment_duration; |

| | |
|---|---|
| bit(1) | contains_RAP; |

| | |
|---|---|
| unsigned int(31) | RAP_delta_ time; |

}
}

In the following the terminology used in the pseudo code will be shortly explained.

reference_track_ID provides the track_ID for the reference track.

track_count: the number of tracks indexed in the following loop; track_count is 1 or greater;

reference_count: the number of elements indexed by second loop; reference_count is 1 or greater;

track_ID: the ID of a track for which a track fragment is included in the first movie fragment identified by this index; exactly one track_ID in this loop is equal to the reference_track_ID;

decoding_time: the decoding time for the first sample in the track identified by track_ID in the movie fragment referenced by the first item in the second loop, expressed in the timescale of the track (as documented in the timescale field of the Media Header Box of the track);

reference type: when set to 0 indicates that the reference is to a movie fragment (‘moof’) box; when set to 1 indicates that the reference is to a segment index (‘sidx’) box;

reference_offset: the distance in bytes from the first byte following the containing segment index box, to the first byte of the referenced box;

subsegment_duration: when the reference is to segment index box, this field carries the sum of the subsegment_duration fields in the second loop of that box; when the reference is to a movie fragment, this field carries the sum of the sample durations of the samples in the reference track, in the indicated movie fragment and subsequent movie fragments up to either the first movie fragment documented by the next entry in the loop, or the end of the subsegment, whichever is earlier; the duration is expressed in the timescale of the track, as documented in the timescale field of the Media Header Box of the track;

contains_RAP: when the reference is to a movie fragment, then this bit may be 1 if the track fragment within that movie fragment for the track with track_ID equal to reference_track_ID contains at least one random access point, otherwise this bit is set to 0; when the reference is to a segment index, then this bit is set to 1 only if any of the references in that segment index have this bit set to 1, and 0 otherwise;

RAP_delta_time: if contains_RAP is 1, provides the presentation (composition) time of a random access point (RAP); reserved with the value 0 if contains_RAP is 0. The time is expressed as the difference between the decoding time of the first sample of the subsegment documented by this entry and the presentation (composition) time of the random access point, in the track with track_ID equal to reference_track_ID.

A stream access point (SAP) is position in a Representation that is identified as being a position for which it is possible to start playback of a media stream using only the information contained in Representation data starting from that position onwards, preceded by initialising with the data in the Initialisation Segment, if any.

Each SAP has six properties, ISAP, TSAP, ISAPAU, TDEC, TEPT, and TPTF defined as follows:

1. TSAP is the earliest presentation time of any access unit of the media stream such that all access units of the media stream with presentation time greater than or equal to TSAP can be correctly decoded using data in the Representation starting at ISAP and no data before ISAP.

2. ISAP is the greatest position in the Representation such that all access units of the media stream with presentation time greater than or equal to TSAP can be correctly decoded using Representation data starting at ISAP and no data before ISAP.

3. ISAPAU is the starting position, in the Representation, of the latest access unit, in decoding order, of the media steam such that all access units of the media stream with presentation time greater than or equal to TSAP can be correctly decoded using the latest access unit and access units following in decoding order and no access units earlier in decoding order.

4. TDEC is the earliest presentation time of any access unit of the media stream that can be correctly decoded using the access unit starting at ISAPAU and access units following in decoding order and no access units earlier in decoding order.

5. TEPT is the earliest presentation time of any access unit of the media stream starting at ISAPAU in the Representation.

6. TPTF is the presentation time of the first access unit of the media stream in decoding order in the Representation starting at ISAPAU.

The following types of SAPs are defined:
Type 1: TEPT=TDEC=TSAP=TPTF
Type 2: TEPT=TDEC=TSAP<TPTF
Type 3: TEPT<TDEC=TSAP<=TPTF
Type 4: TEPT<TDEC=TSAP and TPTF<TSAP
Type 5: TEPT=TDEC<TSAP
Type 6: TEPT<TDEC<TSAP

Type 1 corresponds to what is known in some coding schemes as a “Closed GOP random access point” (in which all access units, in decoding order, starting from ISAPAU can be correctly decoded, resulting in a continuous time sequence of correctly decoded access units with no gaps) and in addition the access unit in decoding order is also the first access unit in presentation order.

Type 2 corresponds to what is know in some coding schemes as a “Closed GOP random access point”, for which the first access unit in decoding order in the media stream starting from ISAPAU is not the first access unit in presentation order.

Type 3 corresponds to what is known in some coding schemes as an “Open GOP random access point”, in which there are some access units in decoding order following ISAPAU that can not be correctly decoded and have presentation times less than TSAP.

Type 4 corresponds to what is known in some coding schemes as an “Gradual Decoding Refresh (GDR) random access point”, in which there are some access units in decoding order following ISAPAU that can not be correctly decoded and have presentation times less than TSAP.

In the dynamic adaptive HTTP streaming, the first SAP within a subsegment may be indicated with a Segment Index box.

Stream switching between representations having different decoded picture buffering requirements in a DASH session has been discussed in MPEG document M20400. The DASH specification assumes that representations share a common timeline. However, if representations of the same adaptation set have different decoded picture buffering requirements, the composition times of the respective pictures, originating from the same uncompressed picture, differ between representations. Three possible solutions are outlined in MPEG document M20400 to indicate a common timeline for all the representations. First, all representations can be encapsulated with the same first frame composition offset, or composition time. However, this is not what encoding/encapsulation tools generally do, but rather they minimize the first frame composition offset. This also implies that the first frame composition offset for all the presentations is dictated by the representation with the greatest frame reordering. Second, it is possible to use signed composition offsets so that the first frame composition time is zero for all representations. This is essentially identical to the first option in the sense that the difference between decoding times and composition times is in practice dictated by the representation with the greatest frame reordering. However, many devices and tools exist and are in use today which do not support signed composition offsets. Third, it is possible to use Edit Lists with empty edits such that the first frame has a presentation time aligned with the other representations. This option is similar to the previous option in a sense that the delay between the start of the decoding and the start of the playback is dictated by the representation with the greatest frame reordering.

In the following some further examples of switching from one stream to another stream will be described in more detail. In receiver-driven stream switching or bitrate adaptation, which is used for example in adaptive HTTP streaming such as DASH, the client may determine a need for switching from one stream having certain characteristics to another stream having at least partly different characteristics for example on the following basis.

The client may estimate the throughput of the channel or network connection for example by monitoring the bitrate at which the requested segments are being received. The client may also use other means for throughput estimation. For example, the client may have information of the prevailing average and maximum bitrate of the radio access link, as determined by the quality of service parameters of the radio access connection. The client may determine the representation to be received based on the estimated throughput and the bitrate information of the representation included in the MPD. The client may also use other MPD attributes of the representation when determining a suitable representation to be received. For example, the computational and memory resources indicated to be reserved for the decoding of the representation should be such that the client can handle. Such computational and memory resources may be indicated by a level, which is a defined set of constraints on the values that may be taken by the syntax elements and variables of the standard (e.g. Annex A of the H.264/AVC standard).

In addition or instead, the client may determine the target buffer occupancy level for example in terms of playback duration. The target buffer occupancy level may be set for example based on expected maximum cellular radio network handover duration. The client may compare the current buffer occupancy level to the target level and determine a need for representation switching if the current buffer occupancy level deviates from the target level significantly. A client may determine to switch to a lower-bitrate representation if the buffer occupancy level is below the target buffer level subtracted by a certain threshold. A client may determine to switch to a higher-bitrate representation if the buffer occupancy level exceeds the target buffer level plus another threshold value.

In server-driven stream switching or bitrate adaptation, the server may determine a need for switching from one stream having certain characteristics to another stream having at least partly different characteristics on similar basis as in the client-driven stream switching as explained above. To assist the server, the client may provide indications to the server for example on the received bitrate or packet rate or on the buffer occupancy status of the client. RTCP can be used for such feedback or indications. For example, an RTCP extended report with receiver buffer status indications, also known as RTCP APP packet with client buffer feedback (NADU APP packet), has been specified in the 3GPP packet-switched streaming service.

The switch-from stream and the switch-to stream may be different representations of the same video content, e.g., the same program, or they may belong to different video contents. The switch-from stream and the switch-to stream have different stream delivery properties such as the bit rate, initial buffering requirements, rate of decoding etc.

According to embodiments of the present invention, decoding or transmission of selected sub-sequences may be omitted when switching from one stream to another stream is started. Consequently, the initial buffering required for uninterrupted decoding and playback of the switch-to stream may be tailored to suit to the buffering status of the switch-from stream in such a way that no pause in playback appears due to switching.

Embodiments of the present invention are applicable in players where access to the start of the switch-to bitstream is faster than the natural decoding rate of the bitstream that results into playback at normal rate. Examples of such players are stream playback from a mass memory and clients of adaptive HTTP streaming. Players choose which sub-sequences of the bitstream are not decoded.

Embodiments of the present invention can also be applied by servers or senders for unicast delivery. The sender chooses which sub-sequences of the bitstream are transmitted to the receiver when the server has decided or the receiver has requested switching from one stream to another stream.

Embodiments of the present invention can also be applied by file generators that create instructions for switching from one stream to another stream. The instructions can be applied in local playback, when switching representations in adaptive HTTP streaming, or when encapsulating the bitstream for unicast delivery.

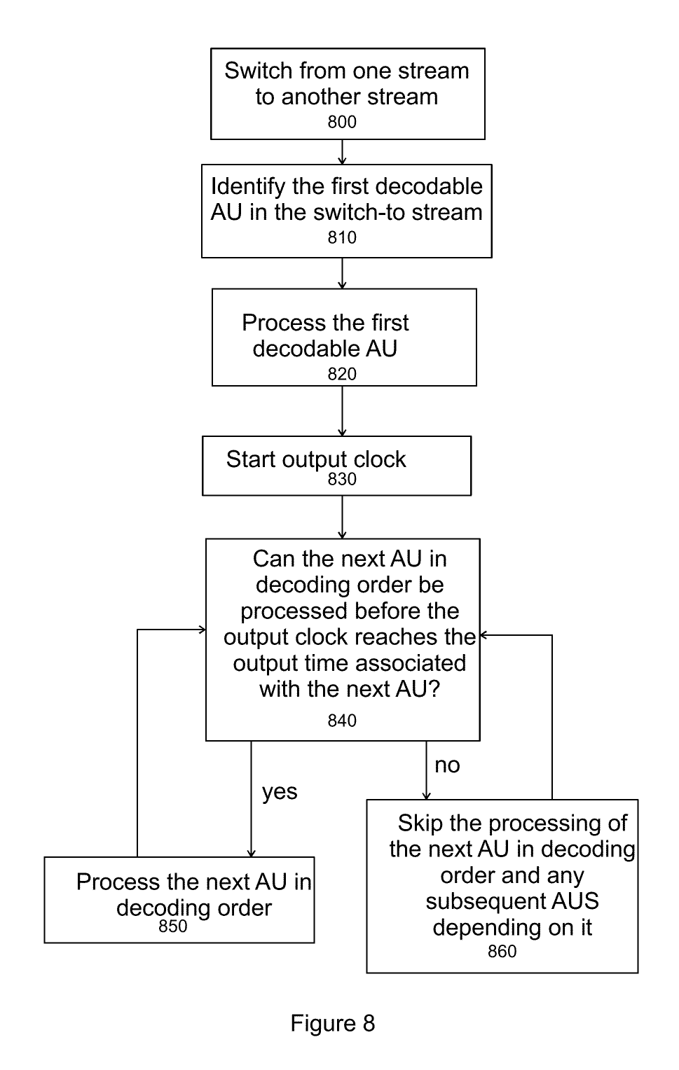

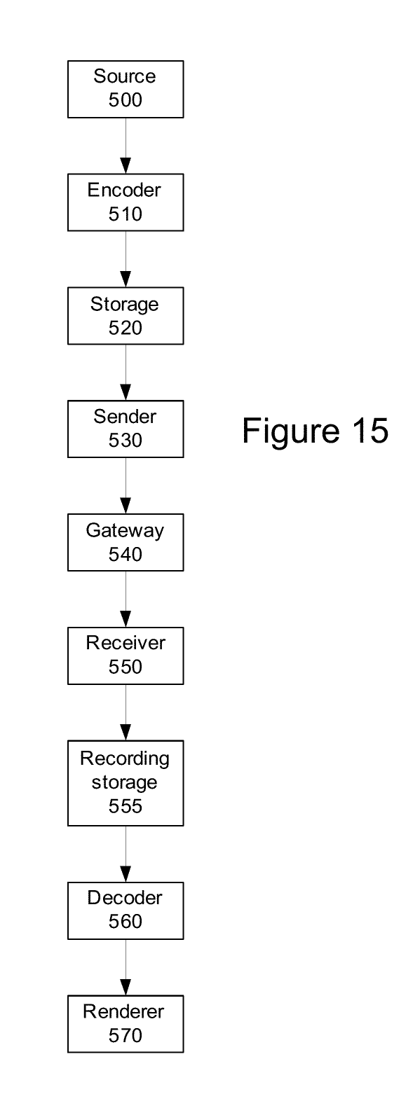

Referring now to FIG. 8, an example implementation of an embodiment of the present invention is illustrated. The process 800 illustrated in FIG. 8 may be performed for example in a Content Provider (block 300 in FIG. 19), in Dynamic Streaming Server (block 410 in FIG. 19), in a file generator, or in an encoder (block 510 in FIG. 15). The process illustrated in FIG. 8 may result into various indications, such as Alternative Startup Sequence sample groups (including both Sample Group Description boxes and Sample to Group boxes for the Alternative Startup Sequences sample groups) within one or more container files.

At block 810 of FIG. 8, the first decodable access unit is identified among those access units that the processing unit has access to. A decodable access unit can be defined, for example, in one or more of the following ways:
An IDR access unit;
An SVC access unit with an IDR dependency representation for which the dependency_id is smaller than the greatest dependency_id of the access unit;
An MVC access unit containing an anchor picture;
An access unit including a recovery point SEI message, i.e., an access unit starting an open GOP (when recovery_frame_cnt is equal to 0) or a gradual decoding refresh period (when recovery_frame_cnt is greater than 0);
An access unit containing a redundant IDR picture;
An access unit containing a redundant coded picture associated with a recovery point SEI message.

In the broadest sense, a decodable access unit may be any access unit. Then, prediction references that are missing in the decoding process are ignored or replaced by default values, for example.

The access units among which the first decodable access unit is identified depends on the functional block where the invention is implemented. If the invention is applied in a player accessing a bitstream from a mass memory, a client for adaptive HTTP streaming, or a sender, the first decodable access unit can be any access unit starting from the desired switching position or it may be the first decodable access unit preceding or at the desired switching position.

The first decodable access unit can be identified by multiple means including the following:
Indication in the video bitstream, such as nal_unit_type equal to 5, idr_flag equal to 1, or recovery point SEI message present in the bitstream.
Indicated by the transport protocol, such as the A bit of the PACSI NAL unit of the SVC RTP payload format. The A bit indicates whether CGS or spatial layer switching at a non-IDR layer representation (a layer representation with nal_unit_type not equal to 5 and idr_flag not equal to 1) can be performed. With some picture coding structures a non-IDR intra layer representation can be used for random access. Compared to using only IDR layer representations, higher coding efficiency can be achieved. The H.264/AVC or SVC solution to indicate the random accessibility of a non-IDR intra layer representation is using a recovery point SEI message. The A bit offers direct access to this information, without having to parse the recovery point SEI message, which may be buried deeply in an SEI NAL unit. Furthermore, the SEI message may not be present in the bitstream.
Indicated in the container file. For example, the Sync Sample Box, the Shadow Sync Sample Box, the Random Access Recovery Point sample grouping, the Track Fragment Random Access Box can be used in files or segments compatible with the ISO Base Media File Format.
The Segment Index box for media segments used in adaptive HTTP streaming and possibly other delivery mechanisms.
Indicated in the packetized elementary stream.

Referring again to FIG. 8, at block 820, the first decodable access unit of the switch-to stream is processed. The method of processing depends on the functional block where the example process of FIG. 8 is implemented. If the process is implemented in a player, processing may comprise decoding. If the process is implemented in a sender, processing may comprise encapsulating the access unit into one or more transport packets and transmitting the access unit as well as (potentially hypothetical) receiving and decoding of the transport packets for the access unit. If the process is implemented in a file creator, processing may comprise writing (into a file, for example) instructions which sub-sequences should be decoded or transmitted in an accelerated switching procedure.

In some embodiments, the time at which block 820 is performed depends on the processing of the switch-from stream. For example, block 820 may be performed when all access units, until the earliest presentation time of the switch-to stream starting from the first decodable access unit, of the switch-from stream have been decoded.

At block 830, the output clock is initialized and started. In some embodiments, the time at which block 830 is performed depends on the processing of the switch-from stream. For example, the output clock may be initialized when all access units, until the earliest presentation time of the switch-to stream starting from the first decodable access unit, of the switch-from stream have been presented. In some embodiments, the switch-from and switch-to streams share the same output or presentation timeline. Thus, the output clock of the switch-to stream is initialized to the present value of the output clock of the switch-from stream.

Additional operations simultaneous to the starting of the output clock may depend on the functional block where the process is implemented. If the process is implemented in a player, the decoded picture resulting from the decoding of the first decodable access unit can be displayed simultaneously to the starting of the output clock. If the process is implemented in a sender, the (hypothetical) decoded picture resulting from the decoding of the first decodable access unit can be (hypothetically) displayed simultaneously to the starting of the output clock. If the process is implemented in a file creator, the output clock may not represent a wall clock ticking in real-time but rather it can be synchronized with the decoding or composition times of the access units.

In various embodiments, the order of the operation of blocks 820 and 830 may be reversed.

At block 840, a determination is made as to whether the next access unit in decoding order can be processed before the output clock reaches the output time of the next access unit. In some embodiments, alternative startup sequences or other indications are used for the determination at block 840. For example, an alternative startup sequence that determines the access units being processed may be determined for the first decodable access unit in the switch-to sequence based on buffer occupancy, decoding start time and output clock.

The method of processing at block 840 depends on the functional block where the process is implemented. If the process is implemented in a player, processing may comprise decoding. If the process is implemented in a sender, processing may comprise encapsulating the access unit into one or more transport packets and transmitting the access unit as well as (potentially hypothetical) receiving and decoding of the transport packets for the access unit. If the process is implemented in a file creator, processing may be defined as above for the player or the sender depending on whether the instructions are created for a player or a sender, respectively.

It is noted that if the process is implemented in a sender or in a file creator that creates instructions for bitstream transmission, the decoding order may be replaced by a transmission order which need not be the same as the decoding order.

In another embodiment, the output clock and processing are interpreted differently when the process is implemented in a sender or a file creator that creates instructions for transmission. In this embodiment, the output clock is regarded as the transmission clock. At block 840, it is determined whether the scheduled decoding time of the access unit appears before the output time (i.e., the transmission time) of the access unit. The underlying principle is that an access unit should be transmitted or instructed to be transmitted (e.g., within a file) before its decoding time. Term processing comprises encapsulating the access unit into one or more transport packets and transmitting the access unit—which, in the case of file creator, are hypothetical operations that the sender would do when following the instructions given in the file.

If the determination is made at block 840 that the next access unit in decoding order can be processed before the output clock reaches the output time associated with the next access unit, the process proceeds to block 850. At block 850, the next access unit is processed. Processing is defined the same way as in block 820. After the processing at block 850, the pointer to the next access unit in decoding order is incremented by one access unit, and the procedure returns to block 840.

On the other hand, if the determination is made at block 840 that the next access unit in decoding order cannot be processed before the output clock reaches the output time associated with the next access unit, the process proceeds to block 860. At block 860, the processing of the next access unit in decoding order is omitted. In addition, the processing of the access units that depend on the next access unit in decoding is omitted. In other words, the sub-sequence having its root in the next access unit in decoding order is not processed. Then, the pointer to the next access unit in decoding order is incremented by one access unit (assuming that the omitted access units are no longer present in the decoding order), and the procedure returns to block 840.

The procedure is stopped at block 840 if there are no more access units in the bitstream.

In an alternative implementation, more than one frame are processed before the output clock is started. The output clock may not be started from the output time of the first decoded access unit but a later access unit may be selected. Correspondingly, the selected later frame is transmitted or played simultaneously when the output clock is started.

In one embodiment, an access unit may not be selected for processing even if it could be processed before its output time. This is particularly the case if the decoding of multiple consecutive sub-sequences in the same temporal level is omitted.

The process illustrated in FIG. 8 may be used to create into various indications, such as Alternative Startup Sequence sample groups (including both Sample Group Description boxes and Sample to Group boxes for the Alternative Startup Sequences sample groups) within one or more container files. Such indications may be created by selecting the time when block 820 is executed (i.e., the initial coded picture buffering delay) and a certain time for when the output clock is started at block 830. For example, if a first stream is known to require an initial decoded buffering delay of M picture intervals and a second stream is known to require an initial decoded picture buffering delay of N picture intervals, where M<N, the process of FIG. 8 can be performed for random access points of the second stream in such a manner that the output clock is started at M picture intervals after the decoding of the first decodable access unit. The alternative startup sequences created this way would enable switching from the first stream to the second stream in such a manner that the streams require an equal amount of initial decoded picture buffering and hence no playback interruptions due to the switch would occur.

Indications can be made available that help in the process illustrated in FIG. 8. The indications can be included in the bitstream, e.g. as SEI messages, in the packet payload structure, in the packet header structure, in the packetized elementary stream structure and in the file format or indicated by other means. The indications discussed in this section can be created by the encoder, by a unit that analyzes bitstream, or by a file creator, for example.

In order to assist a decoder, receiver or player to select which sub-sequences are omitted from decoding, indications of the temporal scalability structure of the bitstream can be provided. One example is a flag that indicates whether or not a regular “bifurcative” nesting structure as illustrated in FIG. 2a is used and how many temporal levels are present (or what is the GOP size). Another example of an indication is a sequence of temporal_id values, each indicating the temporal_id of an access unit in decoding order. The temporal_id of any picture can be concluded by repeating the indicated sequence of temporal_id values, i.e., the sequence of temporal_id values indicates the repetitive behavior of temporal_id values. A decoder, receiver, or player according to the invention selected the omitted and decoded sub-sequences based on the indication.

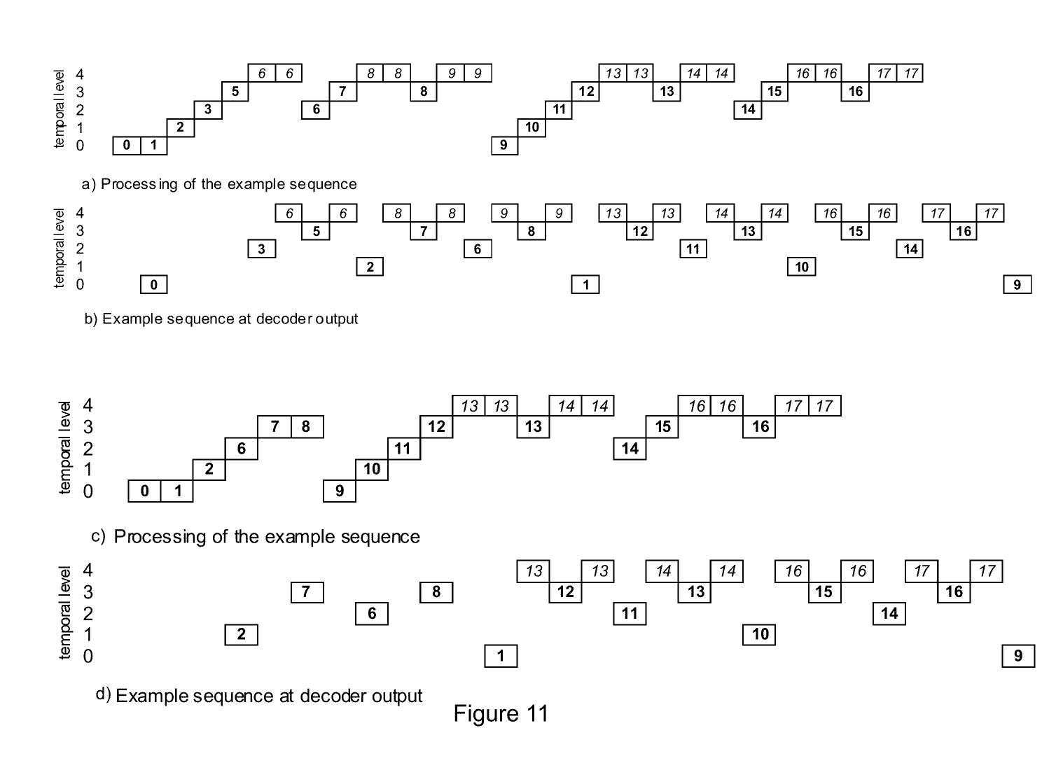

The intended first decoded picture for output can be indicated. This indication assists a decoder, receiver, or player to perform as expected by a sender or a file creator. For example, it can be indicated that the decoded picture with frame_num equal to 2 is the first one that is intended for output in the example of FIGS. 11c-11d. Otherwise, the decoder, receiver, or player may output the decoded picture with frame_num equal to 0 first and the output process would not be as intended by the sender or file creator and the saving in startup delay might not be optimal.

HRD parameters for starting the decoding from an associated first decodable access unit (rather than earlier, e.g., from the beginning of the bitstream) can be indicated. These HRD parameters indicate the initial CPB and DPB delays that are applicable when the decoding starts from the associated first decodable access unit.

Some embodiments of the present invention may enhance stream switching in adaptive streaming by detecting if the initial buffering requirements for the switch-to stream are longer than buffering delays of the switch-from stream at the point of the switch, and processing/decoding the switch-to stream according to an alternative startup sequence, which omits the decoding of one or more pictures and may reduce the required initial buffering requirements of the switch-to stream.

Therefore, seamless stream switching may be achieved with no glitches or interruptions in the audio playback and barely perceivable jitter in the video playback in contrast to approaches, which suffer from noticeable audio interruptions/glitches or increased startup delay for all streams.

There may be variations in the client operation. The client may be, for example, a DASH client. A DASH client can operate as follows. Initially, it can extract
the duration of the empty edit, aᵢ,
compositionStartTime of the first media sample of the track (in the first movie fragment), bᵢ,
compositionToDTSShift, cᵢ, and
the greatest value of min_initial_alt_startup_offset, dᵢ,
   from the Initialisation Segment of each Representation i of an Adaptation Set.

The DASH client can derive for each Representation i a normalized composition start time eᵢ and an alternative composition start time fᵢ on a common timeline for decoding and composition times starting from decoding time 0 as follows: eᵢ=bᵢ+cᵢ and fᵢ=bᵢ+cᵢ−dᵢ. The alternative composition start time represents the smallest composition time of the first sample of the track, in output order, when the composition time offsets are non-negative. Let e be the greatest value of eᵢ. The duration of empty edits aᵢ for each Representation i in the Adaptation Set is normally equal to e−eᵢ. Let f be the greatest value of fᵢ. The alternative empty edit duration gᵢ for each Representation i in the Adaptation Set is equal to f−fᵢ.

At the beginning of the streaming session, the DASH client may choose to request Segments from one Representation j from the Adaptation Set. The selection is typically done so that the average bitrate or bandwidth of the Representation meets and does not exceed the expected throughput of the channel as closely as possible. If gⱼ is smaller than aⱼ, the client can choose to apply the alternative startup sequence when a need arises, and the client therefore shifts the composition times of the track by gⱼ instead of aⱼ and a startup advance time variable h is initialized to aⱼ−gⱼ. Otherwise, the client operates as governed by the Edit List box of the track and shifts the composition times of the track by aⱼ and h is initialized to 0.

If a DASH client chooses to switch Representations from the switch-from Representation j to the switch-to Representation k during the streaming session and the startup advance time variable h is greater than 0, the client can operate as follows. The client can choose an alternative startup sequence from Representation k for which sample_offset[1] is greater than or equal to h, and then decode and render that alternative startup sequence. The startup advance time variable h is updated by subtracting sample_offset[1] of the chosen alternative startup sequence from it.

If a DASH client chooses to switch Representations from the switch-from Representation j to the switch-to Representation k during the streaming session and the startup advance time variable h is equal to (or less than) 0, the client can decode and render the switch-to Representation conventionally, i.e. decode and render samples as governed by the type of the SAP used for accessing Representation k.

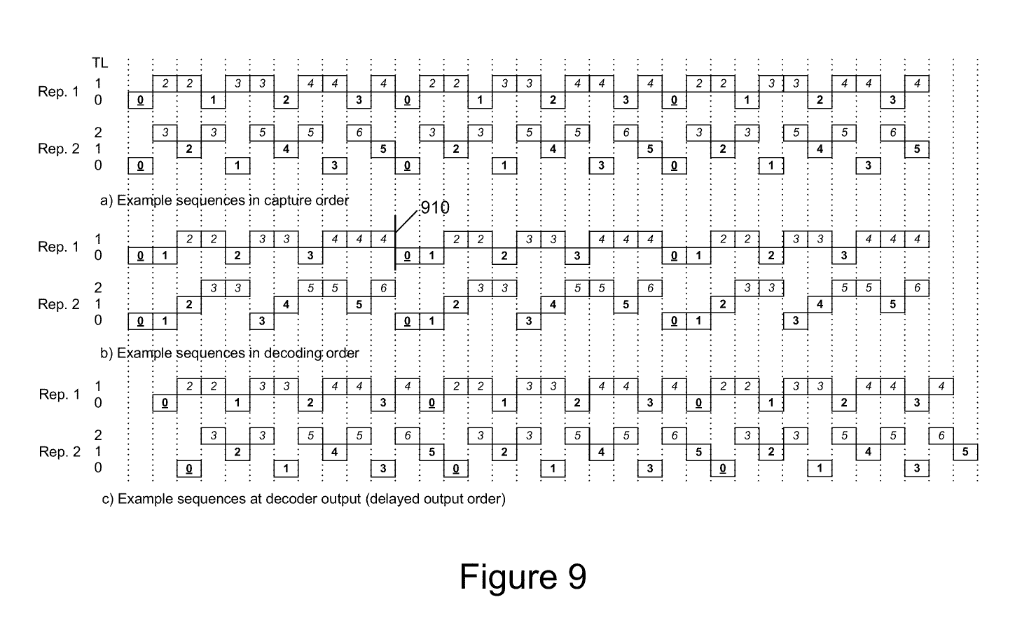

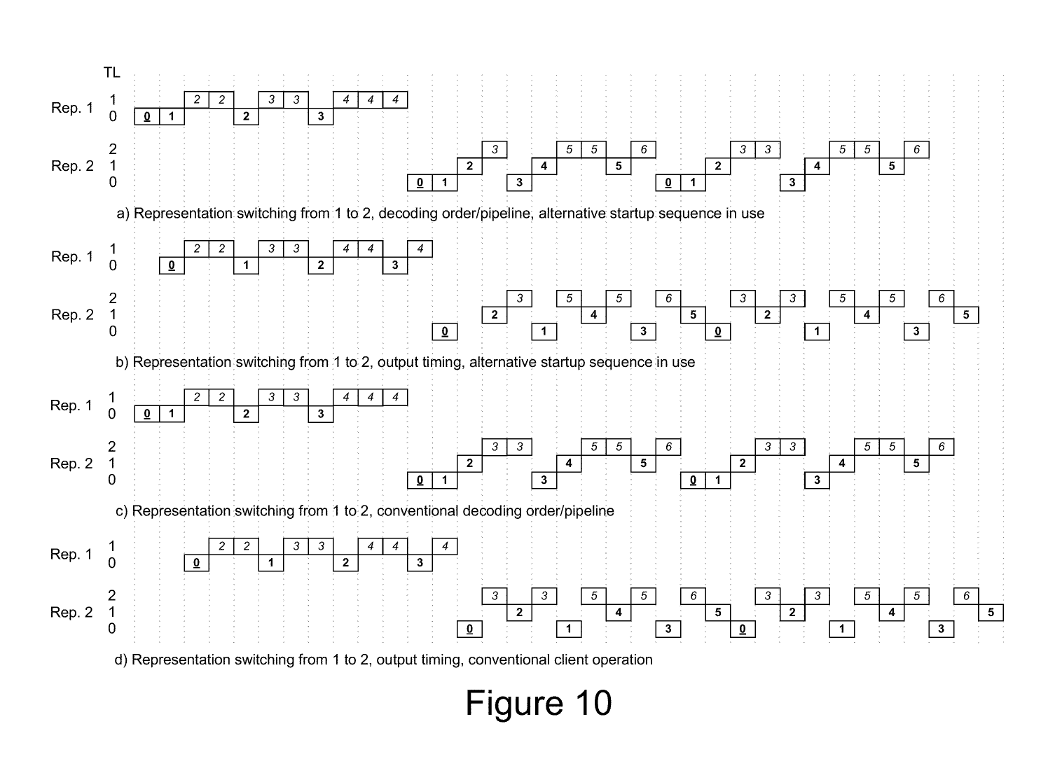

An example of a potential operation of DASH client is provided with FIGS. 9 and 10. In the presented example two representations are coded with H.264/AVC: Representation 1 uses a so-called IBBP inter prediction hierarchy, whereas Representation 2 uses a nested hierarchical temporal scalability hierarchy of three temporal levels. There are ten non-IDR pictures between each two consecutive IDR pictures in both representations. FIG. 9a illustrates the coding pattern of the representations in capture order.

The notation used in FIG. 9 is explained as follows. Values enclosed in boxes indicate the frame_num value of the picture. Values in italics indicate a non-reference picture while the other pictures are reference pictures. Values underlined indicate an IDR picture, whereas other pictures are non-IDR pictures. In order to keep FIG. 9 simple, no arrows indicating inter prediction are included. Pictures at temporal level 1 and above are bi-predicted from the preceding picture at a lower temporal level and from the succeeding picture at a lower temporal level, if that picture is a non-IDR picture.

The decoding order of the coded pictures in the representations is illustrated in FIG. 9b. FIG. 9c shows the picture sequences of the representations in output order when assuming that the output timeline coincides with that of the decoding timeline and the decoding of one picture lasts one picture interval. It can be seen that the initial decoded picture buffering delay for Representation 2 is one picture interval longer than that for Representation 1 due to the different inter prediction hierarchy. If empty edits are used to align the presentation start time of the first frame of the representations, an empty edit having duration of one picture interval is inserted in Representation 1.

In the example given in FIGS. 9 and 10
the empty durations a₁ and a₂ are 1 and 0, respectively, in terms of picture intervals,
compositionStartTime of the first media sample of the track (in the first movie fragment), b₁ and b₂ are 1 and 2, respectively, in terms of picture intervals,
compositionToDTSShift, c₁=c₂=0, and
the greatest value of min_initial_alt_startup_offset, d₁ and d₂ are 0 and 1, respectively, in terms of picture intervals. (No alternative startup sequences are provided for Representation 1, whereas for Representation 2 there is an alternative startup sequence provided for each SAP, which yields min_initial_alt_startup_offset, d₂, equal to 1 in terms of picture intervals, as illustrated in FIG. 10b and explained below.)

Consequently, for the example given in FIGS. 9 and 10,
normalized composition start time e₁=1
normalized composition start time e₂=2
alternative composition start time f₁=1
alternative composition start time f₂=1
the greatest normalized composition start time e=2
the greatest alternative composition start time f=1
duration of the empty edit a₁=1
duration of the empty edit a₂=0
alternative empty edit duration g₁=0
alternative empty edit duration g₂=0
   where all values are in terms of picture intervals.

In the example of FIGS. 9 and 10, the DASH client chooses to start streaming from Representation 1. As g₁<a₁, the client can choose whether to operate conventionally and shift the composition times on the presentation timeline by a₁ (by delaying the output of the decoded sequence) or whether to apply alternative startup sequences when a need arises and shift the composition times on the presentation timeline by g₁=0. In the example of FIGS. 10a and 10b, the client decides to use alternative startup sequences and therefore the first IDR picture is displayed immediately after its decoding as can be observed from FIGS. 10a and 10b. Startup advance time variable h is initialized to a₁−g₁=1

Referring to the example of FIGS. 9 and 10, when the DASH client decides to switch from Representation 1 to Representation 2 at the second IDR picture, it notices that startup advance time variable h is greater than 0 and therefore uses the alternative startup sequence for decoding and rendering Representation 2. In this particular alternative startup sequence, the first non-reference picture is not decoded or rendered (the first picture with frame_num 3 in italics). Consequently, the first decoded IDR picture of Representation 2 is rendered over two picture intervals as can be observed from FIG. 10b. The regular playback rate is achieved at picture having frame_num equal to 2 (see FIG. 10b).

In the following, as an example, the process of FIG. 8 is illustrated as applied to the sequences of FIG. 9. In FIG. 9a an example of the switch-from sequence Rep. 1 and an example of the switch-to sequence Rep. 2 is depicted in capture order. FIG. 9b illustrates the example sequences of FIG. 9a in decoding order, and FIG. 9c illustrates the example sequences of FIG. 9a in output order. FIGS. 10a-10b illustrate example sequences of FIG. 9a in decoding order and in output order, respectively, in connection with switching from stream Rep. 1 to the stream Rep. 2 of FIG. 9a in accordance with an embodiment of the present invention. FIGS. 10c-10d illustrate example sequences of FIG. 9a in decoding order and in output order when a delayed switching is used in connection with switching from Rep. 1 to the stream Rep. 2 of FIG. 9a.

For illustrative purposes only, it is assumed that switching occurs at the location 910 of the switch-from sequence Rep. 1 of FIG. 9b. FIG. 9a and FIG. 9b are horizontally aligned in such a way that the earliest timeslot a decoded picture can appear in the decoder output in FIG. 9b is the next timeslot relative to the processing timeslot of the respective access unit in FIG. 9a. Frames of Rep. 1 are processed (decoded) until the switch point. The block diagram of FIG. 8 represents the processing of the switch-to sequence Rep. 2 as follows.

At block 810 of FIG. 8, the access unit with frame_num equal to 0 of the switch-to sequence Rep. 2 is identified as the first decodable access unit.

At block 820 of FIG. 8, the access unit with frame_num equal to 0 is processed.

At block 830 of FIG. 8, the output clock is started and the decoded picture resulting from the (hypothetical) decoding of the access unit with frame_num equal to 0 is (hypothetically) output.

Blocks 840 and 850 of FIG. 8 are iteratively repeated for access units with frame_num equal to 1, and 2, because they can be processed before the output clock reaches their output time.

When the access unit with frame_num equal to 3 is the next one in decoding order, its output time has already passed. Thus, the first access unit having frame_num equal to 3 in the first processed GOP of the Rep. 2 is skipped (block 860 of FIG. 8).

Blocks 840 and 850 of FIG. 8 are then iteratively repeated for all the subsequent access units in decoding order, because they can be processed before the output clock reaches their output time.

In this example, the rendering of pictures starts one picture interval earlier when the procedure of FIG. 8 is applied compared to the conventional approach previously described. When the picture rate is 25 Hz, the saving in startup delay is 40 msec.

As was mentioned above, FIGS. 7a-7c illustrate an example of a hierarchically scalable bitstream with five temporal levels. Due to the temporal hierarchy, it is possible to decode only a subset of the pictures at the beginning of the sequence. Consequently, rendering can be started faster but the displayed picture rate may be lower at the beginning. In other words, a player can make a trade-off between the duration of the initial startup delay and the initial displayed picture rate. FIGS. 11a-11b and FIGS. 11c-11d show two examples of alternative switching sequences where a subset of the bitstream of FIG. 7a is decoded. FIGS. 11a-11b and 11c-11d depict only switch-to sequences.

The samples selected for decoding and the decoder output are presented in FIG. 11a and FIG. 11b, respectively. The reference picture having frame_num equal to 4 and the non-reference pictures having frame_num equal to 5 which depends from the picture having frame_num equal to 4 are not decoded. In this example, the rendering of pictures starts four picture intervals earlier than in FIG. 7c. When the picture rate is 25 Hz, the saving in startup delay is 160 msec. The saving in the startup delay comes with the disadvantage of a lower displayed picture rate at the beginning of the bitstream.

FIGS. 11c-11d illustrate another example sequence in accordance with embodiments of the present invention. In this example, the decoding of the pictures that depend on the picture with frame_num equal to 3 is omitted and the decoding of non-reference pictures within the second half of the first group of pictures is omitted too. The decoded picture resulting from access unit with frame_num equal to 2 is the first one that is output/transmitted. The decoding of sub-sequence containing access units that depend on the access unit with frame_num equal to 3 is omitted and the decoding of non-reference pictures within the second half of the first GOP is omitted too. As a result, the output picture rate of the first GOP is half of normal picture rate, but the display process starts two frame intervals (80 msec in 25 Hz picture rate) earlier than in the conventional solution previously described.

When the processing of a bitstream starts from the intra picture starting an open GOP, the processing of non-decodable leading pictures is omitted. In addition, the processing of decodable leading pictures can be omitted too, provided that those decodable pictures are not used as reference for inter prediction for pictures that follow the intra picture in output order. In addition, one or more sub-sequences occurring after, in output order, the intra picture starting the open GOP are omitted.

If earliest decoded picture in output order is not output (e.g. as a result of processing similar to what is illustrated in FIGS. 11c-11d), additional operations may have to be performed depending on the functional block where the embodiments of the invention are implemented.
If an embodiment of the invention is implemented in a player that receives a video bitstream and one or more bitstreams synchronized with the video bitstream in real-time (i.e., on average not faster than the decoding or playback rate), the processing of some of the first access units of the other bitstreams may have to be omitted in order to have synchronous playout of all the streams and the playback rate of the streams may have to be adapted (slowed down). Any adaptive media playout algorithm can be used.
If an embodiment of the invention is implemented in a sender or a file creator that writes instructions for transmitting streams, the first access units from the bitstreams synchronized with the video bitstream are selected to match the first decoded picture in output time as closely as possible.

If an embodiment of the invention is applied to a switch-to sequence where the first decodable access unit contains the first picture of a gradual decoding refresh period, only access units with temporal_id equal to 0 are decoded. Furthermore, only the reliable isolated region may be decoded within the gradual decoding refresh period.

If the access units are coded with quality, spatial or other scalability means, only selected dependency representations and layer representations may be decoded in order to speed up the decoding process and further reduce the startup delay.

In one embodiment, only a subset of Representations in an Adaptation Set is considered for calculation of values a to g above and Representation switching within that subset is allowed. Other subsets of Representations of the same Adaptation Set may also be derived and used by a DASH client. Thus, if there is great variability in the buffering requirements between Representations, these subsets may enable smaller values of alternative empty edit durations compared to when deriving the alternative empty edit durations from all Representations of the Adaptation Set.

In one embodiment, the client may choose to use zero or any positive constant (unrelated to the properties of the Representations) for the shifting the composition times onto the presentation timeline when the streaming session is started. The client may then use alternative startup sequences even when no switching takes place to increase the buffer occupancy to a level equivalent to the alternative empty edit duration or to the empty edit duration included in the Edit List box.

In one embodiment, the rate of decoding may be varying and different from that assumed in the bitstream and/or by the encoder. An alternative startup sequence may be used to control the buffer occupancy levels (of CPB or DPB or both of them) such that the occupancy levels are sufficiently over a threshold. Stream switching and alternative startup sequences may also be jointly used to control the buffer occupancy levels.

In different embodiments, the initial buffering requirements include the decoded picture buffering requirements or the coded picture buffering requirements or both of them. The buffering requirements can typically be expressed as delay or time of initial buffering and/or buffer occupancy at the end of initial buffering, where the occupancy can be expressed in terms of bytes (particularly in the case of coded picture buffering) and/or in terms of pictures or frames (particularly in the cases of decoded picture buffering). In some embodiments, it is sufficient to detect whether the initial buffering requirements of two streams differ, while in other embodiments the current buffering status, such as occupancy level, may be studied and compared with the initial buffering requirements of the stream which is being switched to.

In one embodiment of the invention, there is a file encapsulator (see FIG. 16) or file creator, which creates alternative startup sequences and indicates them in a file. In addition, the file encapsulator or the file creator may summarize the properties of the alternative startup sequences into a specific location in the file, such as the Alternative Startup Sequence Properties box or the sample description entry table of the alternative startup sequence sample grouping. The file encapsulator or the file creator may include for example the min_initial_alt_startup_offset syntax element or any of the variables a to g above in the summarization of the properties. For some of the properties, the file encapsulator or the file creator may investigate multiple tracks that are intended to be alternatives to each other, such as different Representations within a single Adaptation Set in a DASH session. For example, for the alternative empty edit duration gᵢ, the file encapsulator or the file creator studies all the alternative tracks.

In one embodiment of the invention, an MPD creator is configured to operate as follows. An MPD creator may be included in a file encapsulate or file creator or it may be a separate functional block that may have access to segments or server files. The MPD creator generates a valid MPD for two or more Representations in the same Adaptation Set. The MPD creator may additionally create elements and/or attributes that describe the alternative startup sequence properties of the Representation. An example of the semantic additions to the MPD of MPEG DASH are provided below. An attribute @minAltStartupOffset may appear among the common group, representation and sub-representation attributes or it may appear in the Representation element, for example.

@minAltStartupOffset specifies the time the presentation of the Representation can be initially advanced while enabling switching to any other Representation in the same Adaptation Set at SAP of type 1 to 3 in such a manner that continuous playback can be maintained by potentially applying an alternative startup sequence associated with that SAP. For ISOBMFF, the value of @minAltStartupOffset is equal to one of the values of min_initial_alt_startup_offset in the Alternative Startup Sequence Properties box of the Initialisation Segment, if the box is present.

The MPD creator may operate similarly to the file encapsulator or the file creator to summarize the properties of the alternative startup sequences into the MPD, where the properties may be for example @minAltStartupOffset as described above or any of the variables a to g above in the summarization of the properties.

A DASH client may use the information of the alternative startup sequences included in the MPD similarly to the similar information included in the Initialisation Segment(s) of the Representations. The benefit of using the information in the MPD may be that the client needs not fetch the Initialisation Segments of all Representations and hence may fetch less data, which may reduce the amount of and the delay caused by initial buffering at the beginning of the streaming session.

In one embodiment, an active streaming server instead of a client, such as a DASH client, makes a decision to use alternative startup sequences in stream switching. The server chooses the coded pictures that are transmitted.

In one embodiment, a server file for active streaming servers includes specific hint tracks or sections of hint tracks that describe packetization instructions when switching from one stream to another. The packetization instructions indicate the use of alternative startup sequences such that certain coded pictures are not transmitted and decoding and/or output times of the pictures within the alternative startup sequences may be modified. In one embodiment, there is a file creator that creates hint tracks or sections of hint tracks that describe packetization instructions when switching from one stream to another using alternative startup sequences.

In one embodiment, the streams or Representations are multiplexed, i.e. contain more than one media stream. For example, the streams may be MPEG-2 Transport Streams. The alternative startup sequence for a multiplexed stream may be specified just one of the contained streams, such as the video stream. Consequently, the indications and variables related to the buffering requirements for alternative startup sequences may also be specified for one of the contained streams.

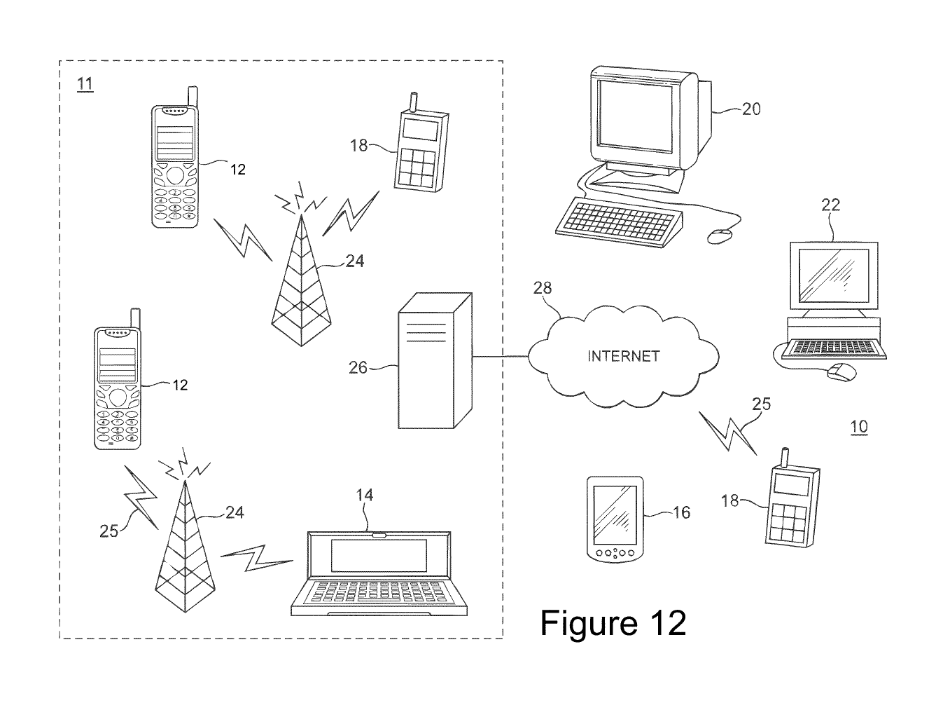

FIG. 12 shows a system 10 in which various embodiments of the present invention can be utilized, comprising multiple communication devices that can communicate through one or more networks. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 12 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, an electronic device 12 in the form of a mobile telephone, a combination personal digital assistant (PDA) and mobile telephone 14, a PDA 16, an integrated messaging device (IMD) 18, a desktop computer 20, a notebook computer 22, etc. The communication devices may be stationary or mobile as when carried by an individual who is moving. The communication devices may also be located in a mode of transportation including, but not limited to, an automobile, a truck, a taxi, a bus, a train, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device involved in implementing various embodiments of the present invention may communicate using various media including, but not limited to, radio, infrared, laser, cable connection, and the like.

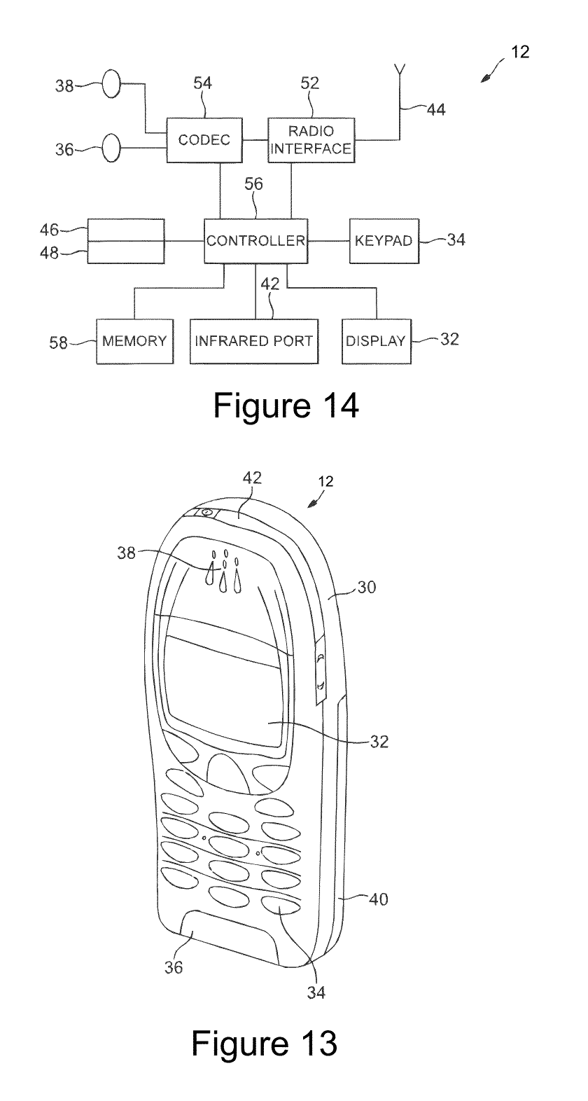

FIGS. 13 and 14 show one representative electronic device 12 which may be used as a network node in accordance to the various embodiments of the present invention. It should be understood, however, that the scope of the present invention is not intended to be limited to one particular type of device. The electronic device 12 of FIGS. 13 and 14 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment, a card reader 48, radio interface circuitry 52, codec circuitry 54, a controller 56 and a memory 58. The above described components enable the electronic device 12 to send/receive various messages to/from other devices that may reside on a network in accordance with the various embodiments of the present invention. Individual circuits and elements are all of a type well known in the art, for example in the Nokia range of mobile telephones.

FIG. 15 is a graphical representation of a generic multimedia communication system within which various embodiments may be implemented. As shown in FIG. 15, a data source 500 provides a source signal in an analog, uncompressed digital, or compressed digital format, or any combination of these formats. An encoder 510 encodes the source signal into a coded media bitstream. It should be noted that a bitstream to be decoded can be received directly or indirectly from a remote device located within virtually any type of network. Additionally, the bitstream can be received from local hardware or software. The encoder 510 may be capable of encoding more than one media type, such as audio and video, or more than one encoder 510 may be required to code different media types of the source signal. The encoder 510 may also get synthetically produced input, such as graphics and text, or it may be capable of producing coded bitstreams of synthetic media. In the following, only processing of one coded media bitstream of one media type is considered to simplify the description. It should be noted, however, that typically real-time broadcast services comprise several streams (typically at least one audio, video and text sub-titling stream). It should also be noted that the system may include many encoders, but in FIG. 15 only one encoder 510 is represented to simplify the description without a lack of generality. It should be further understood that, although text and examples contained herein may specifically describe an encoding process, one skilled in the art would understand that the same concepts and principles also apply to the corresponding decoding process and vice versa.

The coded media bitstream is transferred to a storage 520. The storage 520 may comprise any type of mass memory to store the coded media bitstream. The format of the coded media bitstream in the storage 520 may be an elementary self-contained bitstream format, or one or more coded media bitstreams may be encapsulated into a container file. Some systems operate “live”, i.e. omit storage and transfer coded media bitstream from the encoder 510 directly to the sender 530. The coded media bitstream is then transferred to the sender 530, also referred to as the server, on a need basis. The format used in the transmission may be an elementary self-contained bitstream format, a packet stream format, or one or more coded media bitstreams may be encapsulated into a container file. The encoder 510, the storage 520, and the sender 530 may reside in the same physical device or they may be included in separate devices. The encoder 510 and sender 530 may operate with live real-time content, in which case the coded media bitstream is typically not stored permanently, but rather buffered for small periods of time in the content encoder 510 and/or in the sender 530 to smooth out variations in processing delay, transfer delay, and coded media bitrate.

The sender 530 sends the coded media bitstream using a communication protocol stack. The stack may include but is not limited to Real-Time Transport Protocol (RTP), User Datagram Protocol (UDP), and Internet Protocol (IP). When the communication protocol stack is packet-oriented, the sender 530 encapsulates the coded media bitstream into packets. For example, when RTP is used, the sender 530 encapsulates the coded media bitstream into RTP packets according to an RTP payload format. Typically, each media type has a dedicated RTP payload format. It should be again noted that a system may contain more than one sender 530, but for the sake of simplicity, the following description only considers one sender 530.

If the media content is encapsulated in a container file for the storage 520 or for inputting the data to the sender 530, the sender 530 may comprise or be operationally attached to a “sending file parser” (not shown in the figure). In particular, if the container file is not transmitted as such but at least one of the contained coded media bitstream is encapsulated for transport over a communication protocol, a sending file parser locates appropriate parts of the coded media bitstream to be conveyed over the communication protocol. The sending file parser may also help in creating the correct format for the communication protocol, such as packet headers and payloads. The multimedia container file may contain encapsulation instructions, such as hint tracks in the ISO Base Media File Format, for encapsulation of the at least one of the contained media bitstream on the communication protocol.

The sender 530 may or may not be connected to a gateway 540 through a communication network. The gateway 540 may perform different types of functions, such as translation of a packet stream according to one communication protocol stack to another communication protocol stack, merging and forking of data streams, and manipulation of data stream according to the downlink and/or receiver capabilities, such as controlling the bit rate of the forwarded stream according to prevailing downlink network conditions. Examples of gateways 540 include MCUs, gateways between circuit-switched and packet-switched video telephony, Push-to-talk over Cellular (PoC) servers, IP encapsulators in digital video broadcasting-handheld (DVB-H) systems, or set-top boxes that forward broadcast transmissions locally to home wireless networks. When RTP is used, the gateway 540 is called an RTP mixer or an RTP translator and typically acts as an endpoint of an RTP connection.

The system includes one or more receivers 550, typically capable of receiving, de-modulating, and de-capsulating the transmitted signal into a coded media bitstream. The coded media bitstream is transferred to a recording storage 555. The recording storage 555 may comprise any type of mass memory to store the coded media bitstream. The recording storage 555 may alternatively or additively comprise computation memory, such as random access memory. The format of the coded media bitstream in the recording storage 555 may be an elementary self-contained bitstream format, or one or more coded media bitstreams may be encapsulated into a container file. If there are multiple coded media bitstreams, such as an audio stream and a video stream, associated with each other, a container file is typically used and the receiver 550 comprises or is attached to a container file generator producing a container file from input streams. Some systems operate “live,” i.e. omit the recording storage 555 and transfer coded media bitstream from the receiver 550 directly to the decoder 560. In some systems, only the most recent part of the recorded stream, e.g., the most recent 10-minute excerption of the recorded stream, is maintained in the recording storage 555, while any earlier recorded data is discarded from the recording storage 555.

The coded media bitstream is transferred from the recording storage 555 to the decoder 560. If there are many coded media bitstreams, such as an audio stream and a video stream, associated with each other and encapsulated into a container file, a file parser (not shown in the figure) is used to decapsulate each coded media bitstream from the container file. The recording storage 555 or a decoder 560 may comprise the file parser, or the file parser is attached to either recording storage 555 or the decoder 560.

The coded media bitstream is typically processed further by a decoder 560, whose output is one or more uncompressed media streams. Finally, a renderer 570 may reproduce the uncompressed media streams with a loudspeaker or a display, for example. The receiver 550, recording storage 555, decoder 560, and renderer 570 may reside in the same physical device or they may be included in separate devices.

Various embodiments described herein are described in the general context of method steps or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Embodiments of the present invention may be implemented in software, hardware, application logic or a combination of software, hardware and application logic. For example, some aspects may be implemented in hardware, while other aspects may be implemented in firmware or software which may be executed by a controller, microprocessor or other computing device, although the invention is not limited thereto. The software, application logic and/or hardware may reside, for example, on a chipset, a mobile device, a desktop, a laptop or a server. Software and web implementations of various embodiments can be accomplished with standard programming techniques with rule-based logic and other logic to accomplish various database searching steps or processes, correlation steps or processes, comparison steps or processes and decision steps or processes. Various embodiments may also be fully or partially implemented within network elements or modules. It should be noted that the words “component” and “module,” as used herein and in the following claims, is intended to encompass implementations using one or more lines of software code, and/or hardware implementations, and/or equipment for receiving manual inputs.

The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs) and processors based on multi core processor architecture, as non limiting examples.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

In the following some examples will be provided.

A method comprising:

receiving a first sequence of access units and a second sequence of access units;

decoding at least one access unit of the first sequence of access units;

decoding a first decodable access unit of the second sequence of access units;

determining whether a next decodable access unit in the second sequence of access units can be decoded before at least one of a decoding time of the next decodable access unit in the second sequence of access units and an output time of the next decodable access unit in the second sequence of access units; and

skipping decoding of the next decodable access unit based on determining that the next decodable access unit cannot be decoded before the at least one of the decoding time and the output time of the next decodable access unit.

In some examples the method further comprises:

skipping decoding of any such access units in the second sequence of access units that depend on the next decodable access unit.

In some examples the method further comprises:

decoding the next decodable access unit based on determining that the next decodable access unit can be decoded before the at least one of the decoding time and the output time of the next decodable access unit.

In some examples the method further comprises:

repeating the determining and either the skipping decoding or the decoding the next decodable access unit until there are no more access units.

In some examples the method further comprises:

receiving instructions of an alternative startup sequence for the second sequence of access units;

using the alternative startup sequence in said determining.

In some examples the method further comprises:

the first sequence of access units is a subset of a first representation and the second sequence of access units is a subset of a second representation,

the first representation and the second representation originating from essentially the same media content, and

output times of the first sequence of access units having at least partly different range than output times of the second sequence of access units; the method further comprising:

requesting transmission of the first sequence of access units prior to receiving the first sequence of access units,

determining to request transmission of the second sequence of access units rather than subsequent access units of the first representation, and

requesting transmission of the second sequence of access units prior to receiving the second sequence of access units.

Another example of a method comprises:

receiving a request for switching from a first sequence of access units to a second sequence of access units from a receiver;

encapsulating at least one decodable access unit of the first sequence of access units for transmission;

encapsulating a first decodable access unit of the second sequence of access units for transmission;

determining whether a next decodable access unit in the second sequence of access units can be encapsulated before at least one of a decoding time of the next decodable access unit in the second sequence of access units and a transmission time of the next decodable access unit in the second sequence of access units; and

skipping encapsulation of the next decodable access unit based on determining that the next decodable access unit cannot be encapsulated before the at least one of the decoding time and the transmission time of the next decodable access unit; and

transmitting the encapsulated decodable access units to the receiver.

In some examples the method further comprises:

skipping encapsulation of any access units in the second sequence of access units depending on the next decodable access unit.

In some examples the method further comprises:

encapsulating the next decodable access unit based on determining that the next decodable access unit can be encapsulated before the at least one of the decoding time and the transmission time of the next decodable access unit.

In some examples the method further comprises:

repeating the determining and either the skipping encapsulation or the encapsulating the next decodable access unit until there are no more access units.

In some examples of the method the encapsulating comprises encapsulating the decodable access units into a bitstream.

In some examples of the method the access units are access units of at least one coded video sequence.

Another example of a method comprises:

generating instructions for decoding a first sequence of access units and a second sequence of access units, the instructions comprising:
decoding at least one access unit of the first sequence of access units;
decoding a first decodable access unit of the second sequence of access units;
determining whether a next decodable access unit in the second sequence of access units can be decoded before at least one of a decoding time of the next decodable access unit in the second sequence of access units and an output time of the next decodable access unit in the second sequence of access units; and
generating an instruction to skip decoding of the next decodable access unit based on determining that the next decodable access unit cannot be decoded before the at least one of the decoding time and the output time of the next decodable access unit.

Another example of a method comprises:

generating instructions for encapsulating a first sequence of access units and a second sequence of access units, the instructions comprising:
encapsulating at least one decodable access unit of the first sequence of access units for transmission;
encapsulating a first decodable access unit of the second sequence of access units for transmission;
determining whether a next decodable access unit in the second sequence of access units can be encapsulated before at least one of a decoding time of the next decodable access unit in the second sequence of access units and a transmission time of the next decodable access unit in the second sequence of access units; and
generating an instruction to skip encapsulation of the next decodable access unit based on determining that the next decodable access unit cannot be encapsulated before the at least one of the decoding time and the transmission time of the next decodable access unit.

An apparatus according to an example comprises:

a decoder configured to:
decode at least one access unit of a first sequence of access units;
decode a first decodable access unit of a second sequence of access units;
determine whether a next decodable access unit in the second sequence of access units can be decoded before at least one of a decoding time of the next decodable access unit in the second sequence of access units and an output time of the next decodable access unit in the second sequence of access units; and
skip decoding of the next decodable access unit based on determining that the next decodable access unit cannot be decoded before the at least one of the decoding time and the output time of the next decodable access unit.

An apparatus according to another example comprises:

an encoder configured to:
encapsulate at least one decodable access unit of a first sequence of access units for transmission;
encapsulate a first decodable access unit of a second sequence of access units for transmission;
determine whether a next decodable access unit in the second sequence of access units can be encapsulated before at least one of a decoding time of the next decodable access unit in the second sequence of access units and a transmission time of the next decodable access unit; and
skip encapsulation of the next decodable access unit based on determining that the next decodable access unit cannot be encapsulated before the at least one of the decoding time and the transmission time of the next decodable access unit.

An apparatus according to another example comprises:

a file generator configured to generate instructions to:
decode at least one access unit of a first sequence of access units;
decode a first decodable access unit of a second sequence of access units;
determine whether a next decodable access unit in the second sequence of access units can be decoded before at least one of a decoding time of the next decodable access unit in the second sequence of access units and an output time of the next decodable access unit in the second sequence of access units; and
skip decoding of the next decodable access unit based on determining that the next decodable access unit cannot be decoded before the at least one of the decoding time and the output time of the next decodable access unit.

An apparatus according to another example comprises:

a file generator configured to generate instructions to:
encapsulate at least one decodable access unit of a first sequence of access units for transmission;
encapsulate a first decodable access unit of a second sequence of access units for transmission;
determine whether a next decodable access unit in the second sequence of access units can be encapsulated before at least one of a decoding time of the next decodable access unit in the second sequence of access units and a transmission time of the next decodable access unit; and
skip encapsulation of the next decodable access unit based on determining that the next decodable access unit cannot be encapsulated before the at least one of the decoding time and the transmission time of the next decodable access unit.

An apparatus according to another example comprises:

at least one processor; and

at least one memory including computer program code, the at least one memory and the computer program code are configured to, with the at least one processor, cause the apparatus at least to:
decode at least one access unit of a first sequence of access units;
decode a first decodable access unit of a second sequence of access units;
determine whether a next decodable access unit in the second sequence of access units can be decoded before at least one of a decoding time of the next decodable access unit in the second sequence of access units and an output time of the next decodable access unit in the second sequence of access units; and
skip decoding of the next decodable access unit based on determining that the next decodable access unit cannot be decoded before the at least one of the decoding time and the output time of the next decodable access unit.

In some examples of the apparatus the memory further comprises computer program code, the at least one memory and the computer program code are configured to, with the at least one processor, cause the apparatus at least to:

skip decoding of any such access units in the second sequence of access units that depend on the next decodable access unit.

In some examples of the apparatus the memory further comprises computer program code, the at least one memory and the computer program code are configured to, with the at least one processor, cause the apparatus at least to:

decode the next decodable access unit based on determining that the next decodable access unit can be decoded before the at least one of the decoding time and the output time of the next decodable access unit.

In some examples of the apparatus the memory further comprises computer program code, the at least one memory and the computer program code are configured to, with the at least one processor, cause the apparatus at least to:

repeat the determining and either the skipping decoding or the decoding the next decodable access unit until there are no more access units.

In some examples of the apparatus the memory further comprises computer program code, the at least one memory and the computer program code are configured to, with the at least one processor, cause the apparatus at least to:

receiving instructions of an alternative startup sequence for the second sequence of access units;

using the alternative startup sequence in said determining.

In some examples the first sequence of access units is a subset of a first representation and the second sequence of access units is a subset of a second representation; the first representation and the second representation originating from essentially the same media content, and output times of the first sequence of access units having at least partly different range than output times of the second sequence of access units; wherein

the memory further comprises computer program code, the at least one memory and
the computer program code are configured to, with the at least one processor, cause the apparatus at least to:

request transmission of the first sequence of access units prior to receiving the first sequence of access units,

determine to request transmission of the second sequence of access units rather than subsequent access units of the first representation, and

request transmission of the second sequence of access units prior to receiving the second sequence of access units.

An apparatus according to another example comprises:

a processor; and

a memory including computer program code, the at least one memory and the computer program code are configured to, with the at least one processor, cause the apparatus at least to:
encapsulate at least one access unit of a first sequence of access units for transmission;
encapsulate a first decodable access unit of a second sequence of access units for transmission;
determine whether a next decodable access unit in the second sequence of access units can be encapsulated before at least one of a decoding time of the next decodable access unit in the second sequence of access units and a transmission time of the next decodable access unit in the second sequence of access units; and
skip encapsulation of the next decodable access unit based on determining that the next decodable access unit cannot be encapsulated before the at least one of the decoding time and the transmission time of the next decodable access unit.

In some examples of the apparatus the memory further comprises computer program code, the at least one memory and the computer program code are configured to, with the at least one processor, cause the apparatus at least to:

skip encapsulation of any access units in the second sequence of access units depending on the next decodable access unit.

In some examples of the apparatus the memory further comprises computer program code, the at least one memory and the computer program code are configured to, with the at least one processor, cause the apparatus at least to:

encapsulate the next decodable access unit based on determining that the next decodable access unit can be encapsulated before the at least one of the decoding time and the transmission time of the next decodable access unit.

In some examples of the apparatus the memory further comprises computer program code, the at least one memory and the computer program code are configured to, with the at least one processor, cause the apparatus at least to:

repeat the determining and either the skipping encapsulation or the encapsulating the next decodable access unit until there are no more access units.

In some examples of the apparatus the memory further comprises computer program code, the at least one memory and the computer program code are configured to, with the at least one processor, cause the apparatus at least to encapsulate the decodable access units into a bitstream.

In some examples of the apparatus the memory further comprises computer program code, the at least one memory and the computer program code are configured to, with the at least one processor, cause the apparatus at least to use access units of at least one coded video sequence as said access units.

An example of a computer program product, embodied on a computer-readable medium, comprises:

computer code for decoding at least one access unit of a first sequence of access units;

computer code for decoding a first decodable access unit of a second sequence of access units;

computer code for determining whether a next decodable access unit in the second sequence of access units can be decoded before at least one of a decoding time of the next decodable access unit in the second sequence of access units and an output time of the next decodable access unit in the second sequence of access units; and

computer code for skipping decoding of the next decodable access unit based on determining that the next decodable access unit cannot be decoded before the at least one of the decoding time and the output time of the next decodable access unit.

An example of a computer program product, embodied on a computer-readable medium, comprises:

computer code for encapsulating at least one access unit of a first sequence of access units for transmission;

computer code for encapsulating a first decodable access unit of a second sequence of access units for transmission;

computer code for determining whether a next decodable access unit in the second sequence of access units can be encapsulated before at least one of a decoding time of the next decodable access unit in the second sequence of access units and a transmission time of the next decodable access unit in the second sequence of access units; and

computer code for skipping encapsulation of the next decodable access unit based on determining that the next decodable access unit cannot be encapsulated before the at least one of the decoding time and the transmission time of the next decodable access unit.

What is claimed is:

1. A method comprising:
receiving a first sequence of access units and a second sequence of access units;
decoding at least one access unit of the first sequence of access units;
decoding a first decodable access unit of the second sequence of access units;
determining whether a next decodable access unit in the second sequence of access units can be decoded before at least one of a decoding time of the next decodable access unit in the second sequence of access units and an output time of the next decodable access unit in the second sequence of access units; and
skipping decoding of the next decodable access unit based on determining that the next decodable access unit cannot be decoded before the at least one of the decoding time and the output time of the next decodable access unit.

2. The method according to claim 1, further comprising:
skipping decoding of any such access units in the second sequence of access units that depend on the next decodable access unit.

3. The method according to claim 1, further comprising:
decoding the next decodable access unit based on determining that the next decodable access unit can be decoded before the at least one of the decoding time and the output time of the next decodable access unit.

4. The method according to claim 1, further comprising:
receiving instructions of an alternative startup sequence for the second sequence of access units;
using the alternative startup sequence in said determining.

5. The method according to claim 1, wherein
the first sequence of access units is a subset of a first representation and the second sequence of access units is a subset of a second representation,
the first representation and the second representation originating from essentially the same media content, and
output times of the first sequence of access units having at least partly different range than output times of the second sequence of access units;
the method further comprising:
requesting transmission of the first sequence of access units prior to receiving the first sequence of access units,
determining to request transmission of the second sequence of access units rather than subsequent access units of the first representation, and
requesting transmission of the second sequence of access units prior to receiving the second sequence of access units.

6. An apparatus comprising at least one processor and at least one memory including computer program code, the at least one memory and the computer program code configured to, with the at least one processor, cause the apparatus to:
decode at least one access unit of a first sequence of access units;
decode a first decodable access unit of a second sequence of access units;
determine whether a next decodable access unit in the second sequence of access units can be decoded before at least one of a decoding time of the next decodable access unit in the second sequence of access units and an output time of the next decodable access unit in the second sequence of access units; and
skip decoding of the next decodable access unit based on determining that the next decodable access unit cannot be decoded before the at least one of the decoding time and the output time of the next decodable access unit.

7. The apparatus according to claim 6, said at least one memory stored with code thereon, which when executed by said at least one processor, further causes the apparatus to:
skip decoding of any such access units in the second sequence of access units that depend on the next decodable access unit.

8. The apparatus according to claim 6, said at least one memory stored with code thereon, which when executed by said at least one processor, further causes the apparatus to:
decode the next decodable access unit based on determining that the next decodable access unit can be decoded before the at least one of the decoding time and the output time of the next decodable access unit.

9. The apparatus according to claim 6, said at least one memory stored with code thereon, which when executed by said at least one processor, further causes the apparatus to:
receive instructions of an alternative startup sequence for the second sequence of access units;
use the alternative startup sequence in said determining.

10. An apparatus comprising at least one processor and at least one memory including computer program code, the at least one memory and the computer program code configured to, with the at least one processor, cause the apparatus to:
encapsulate at least one decodable access unit of a first sequence of access units for transmission;
encapsulate a first decodable access unit of a second sequence of access units for transmission;
determine whether a next decodable access unit in the second sequence of access units can be encapsulated before at least one of a decoding time of the next decodable access unit in the second sequence of access units and a transmission time of the next decodable access unit; and
skip encapsulation of the next decodable access unit based on determining that the next decodable access unit cannot be encapsulated before the at least one of the decoding time and the transmission time of the next decodable access unit.
